(19) United States
(12) Patent Application Publication
(10) Pub. No.: US 2024/0094886 A1
(43) Pub. Date: Mar. 21, 2024

(54) APPLYING VISUAL MODIFIERS TO OBJECTS OF INTEREST SELECTED BY A POINTER FROM A VIDEO FEED IN A FRAME BUFFER VIA PROCESSING CIRCUITRY

(71) Applicant: Mobeus Industries, Inc., Sparta, NJ (US)

(72) Inventor: Dharmendra ETWARU, Sparta, NJ (US)

(21) Appl. No.: 18/369,067

(22) Filed: Sep. 15, 2023

Related U.S. Application Data
(60) Provisional application No. 63/407,489, filed on Sep. 16, 2022.

(51) Int. Cl. G06F 3/04845; G06F 3/04815; G06F 3/16; G06T 7/50; G06T 7/70; G06T 11/00

(52) U.S. Cl. CPC G06F 3/04845; G06F 3/04815; G06F 3/167; G06T 7/50; G06T 7/70; G06T 11/00; G06F 2203/04804; G06T 2200/24; G06T 2210/62

(57) ABSTRACT

A device, method, and computer-readable storage medium that detect, in displayed data present in a frame buffer, a region of interest, determine a location corresponding to an interaction, and upon determining the interaction has a position or predicted position located within the region of interest, apply a visual modifier to the region of interest.

### CROSS REFERENCE TO RELATED APPLICATIONS

The present application is a Non-Provisional of and claims priority to U.S. Provisional Application No. 63/407,489, filed Sep. 16, 2022, the entire contents of which is incorporated by reference herein in its entirety for all purposes.

### BACKGROUND

### Field of the Disclosure

The present disclosure relates to mixing multiple data streams shared with another device and modifying digital content in the mixed data streams in real time.

### Description of the Related Art

Displayed data has traditionally been presented within the bounds of a two-dimensional geometric screen. The visual experience of such displayed data is thus lacking in dynamism that allows for the layering of functionality within a given display frame.

The foregoing description is for the purpose of generally presenting the context of the disclosure. Work of the inventors, to the extent it is described in this background section, as well as aspects of the description which may not otherwise qualify as prior art at the time of filing, are neither expressly or impliedly admitted as prior art against the present disclosure.

### SUMMARY

The foregoing paragraphs have been provided by way of general introduction, and are not intended to limit the scope of the following claims. The described embodiments, together with further advantages, will be best understood by reference to the following detailed description taken in conjunction with the accompanying drawings.

In one embodiment, the present disclosure is related to a method, including detecting, in displayed data present in a frame buffer, a region of interest; determining a location corresponding to an interaction; and upon determining the interaction has a position or predicted position located within the region of interest, applying a visual modifier to the region of interest.

In one embodiment, the present disclosure is additionally related to a device, including processing circuitry configured to detect, in displayed data present in a frame buffer, a region of interest, determine a location corresponding to an interaction, and upon determining the interaction has a position or predicted position located within the region of interest, apply a visual modifier to the region of interest.

In one embodiment, the present disclosure is additionally related to a non-transitory computer-readable storage medium for storing computer-readable instructions that, when executed by a computer, cause the computer to perform a method, the method including detecting, in displayed data present in a frame buffer, a region of interest; determining a location corresponding to an interaction; and upon determining the interaction has a position or predicted position located within the region of interest, applying a visual modifier to the region of interest.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic view of user devices communicatively connected to a server, according to an exemplary embodiment of the present disclosure;

FIG. 2A is a flow chart of a method of generating a reference patch and embedding the reference patch into displayed data, according to an exemplary embodiment of the present disclosure;

FIG. 2B is a flow chart of a sub-method of generating the reference patch, according to an exemplary embodiment of the present disclosure;

FIG. 2C is a flow chart of a sub-method of associating the surface area with secondary digital content, according to an exemplary embodiment of the present disclosure;

FIG. 2D is a flow chart of a sub-method of integrating the reference patch into the displayed data, according to an exemplary embodiment of the present disclosure;

FIG. 3A is a flow chart of a method of inspecting the reference patch, according to an exemplary embodiment of the present disclosure;

FIG. 3B is a flow chart of a sub-method of identifying the reference patch with unique identifiers corresponding to the surface area from the stream of data, according to an exemplary embodiment of the present disclosure;

FIG. 3C is a flow chart of a sub-method of associating the unique identifiers with digital content, according to an exemplary embodiment of the present disclosure;

FIG. 4A is a flow chart of a method of identifying the reference patch included in the displayed data and overlaying the secondary digital content into displayed data, according to an exemplary embodiment of the present disclosure;

FIG. 4B is a flow chart of a sub-method of identifying the reference patch with the unique identifiers corresponding to the surface area from the stream of data, according to an exemplary embodiment of the present disclosure;

FIG. 4C is a flow chart of a sub-method of associating the unique identifiers with digital content, according to an exemplary embodiment of the present disclosure;

FIG. 5A is an illustration of a display, according to an exemplary embodiment of the present disclosure;

FIG. 5B is an illustration of a reference patch within a frame of a display, according to an exemplary embodiment of the present disclosure;

FIG. 5C is an illustration of an augmentation within a frame of a display, according to an exemplary embodiment of the present disclosure;

FIG. 6 is an example of transparent computing;

FIG. 7 illustrates an example an augmentation configured to manage, manipulate, and merge multiple layers of content, according to an embodiment of the present disclosure;

FIG. 8A depicts a flowchart outlining the process involved in the method of certain embodiments of present disclosure;

FIG. 8B depicts a flowchart outlining the process involved in managing interactivity, according to an embodiment of the present disclosure;

FIG. 9 is a flow chart of a method of detecting and visually modifying objects, according to an embodiment of the present disclosure;

FIG. 10A is a schematic illustrating a user camera feed mixed with user display content for the purposes of highlighting and hotspotting, according to an embodiment of the present disclosure;

FIG. 10B is a schematic illustrating the detection of a body part of the user, according to an embodiment of the present disclosure;

FIG. 10C is a schematic illustrating a gesture, according to an embodiment of the present disclosure;

FIG. 10D is a schematic illustrating visual modification of the object, according to an embodiment of the present disclosure;

FIG. 10E is a schematic illustrating user input to identify objects and regions of interest, according to an embodiment of the present disclosure;

FIG. 10F is a schematic illustrating duplication of the selected area of interest, according to an embodiment of the present disclosure;

FIG. 11A is a schematic illustrating a slide before object detection, according to an embodiment;

FIG. 11B is a schematic illustrating a slide after object detection, according to an embodiment;

FIG. 12A is a schematic of an example of object detection on a web browser, according to an embodiment of the present disclosure;

FIG. 12B is a schematic of the example of the object detection of FIG. 12A with object edges shown, according to an embodiment of the present disclosure;

FIG. 13 is a schematic of a user device for performing a method, according to an exemplary embodiment of the present disclosure;

FIG. 14 is a schematic of a hardware system for performing a method, according to an exemplary embodiment of the present disclosure; and

FIG. 15 is a schematic of a hardware configuration of a device for performing a method, according to an exemplary embodiment of the present disclosure.

### DETAILED DESCRIPTION

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). Reference throughout this document to “one embodiment”, “certain embodiments”, “an embodiment”, “an implementation”, “an example” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

According to an embodiment, the present disclosure relates to augmentation of a digital user experience. The augmentation may include an overlaying of digital objects onto a viewable display area of a display. The display may be a display of a mobile device such as a smartphone, tablet, and the like, a display of a desktop computer, or another interactive display. The digital objects can include text, symbols images, videos, and other graphical elements, among others. The digital objects can be interactive. The digital objects can be associated with third-party software vendors.

According to an embodiment, the present disclosure is directed to detecting a region in display data present in the frame buffer of the graphics processor, determining a location corresponding to a user interaction, and applying a visual modifier to the region of interest upon determining the user interaction has a position or predicted position which is within the region of interest. Display data refers to data which is capable of being, or configured to be, displayed by a suitable display. The display data can be or include, for example, an image, a video, an animation, or any other suitable display data. The stream of data can comprise non-display data. For example, the stream of data can include audio data.

In the augmentation of a digital user experience that includes overlaying of digital objects onto a viewable display area of a display, certain regions, such as display objects, windows, or portions thereof, can be obscured by other display data. Overlayed digital objects can, if transparent to any degree, cause a partial obscuring or a loss of visual clarity for objects beneath. This can lead to a disadvantageous situation where content which has opaque or non-opaque objects overlayed is not viewable to a necessary degree for a user. For example, even when overlayed with a non-opaque window, text in a document can be difficult to read. This difficulty can arise from, for example, lack of contrast, blurring, visual confusion, or other visual effect that makes the text unreadable for some users. This can be particularly troublesome for users with certain health conditions such as poor eyesight, dyslexia, colorblindness, attention disorders, and the like. Providing a method of rendering content, even with overlayed display data, more visible to a user can be advantageous for overcoming the disadvantages associated with the augmentation described above.

For example, consider a video conference. It can be advantageous to display certain shared content, such as screenshares or whiteboards, as transparent or semi-transparent in a layer separate from a layer containing a video feed of a participant. Such a configuration, however, can lead to situations where the content of the screenshare or whiteboard is difficult to discern from the video feed of the participant. Therefore, it can be advantageous to alter or modify the display parameters of the shared content to, for example, enhance visibility to a participant in the video conference. The alteration or modification of the display parameters can, in some circumstances, result in a region where displayed data in a lower level is completely obscured by displayed data in an upper level, or vice-versa. For example, a portion of the screenshare could be made completely opaque such that it obscures the video feed of a participant. In an example, such a portion could correspond to a graph displaying a certain trendline. While presentation of the entirety of the screenshare can be desired or necessary, it is advantageous to have the ability for a presenting user to modify the display of the graph, trendline, or portion(s) thereof such that they are more visible to participants. When the discussion of the graph or trendline is finished, the presenting user could then remove or reverse the visual alteration. The region of interest (e.g., the graph or trendline) can be indicated by a user input, such as with a pointer associated with a mouse or gesture. This type of visual modification via the user input can be referred to as “highlighting”. It should be understood that the term highlighting can refer to other types of visual modification, further discussion of which appears below. In an example, the region of interest can be automatically determined using computer vision and inspection of displayed data in the frame buffer, and then the visual modification can automatically be applied to the region of interest. This type of automatic visual modification via content-based automatic detection can be referred to as “hotspotting”.

According to an embodiment, the display data can include a user camera feed in one display layer and be mixed with user display content in another display layer. In the example of the video conference, the display content can be, for example, a desktop of a user's device. The displayed data or visual composite of the layer mixing can appear to a viewer, such as the user or another participant in the electronic communication session (e.g., a video conference), as the camera feed of the user being displayed behind the display content. Notably, the display content can include objects, such as shapes, text, or areas, that appear overlayed on the user (user's body, head, face, etc.). The user can interact with these objects even though the user's camera feed is on a separate layer from the user display content. While interacting with the objects, the objects themselves can be visually modified to be more easily recognized by the user or other participant in the electronic communication session. For example, an outline of the object may be emphasized by applying highlighting to or otherwise emphasizing the outline of the object. In doing so, the object can stand out and become the focus of a discussion or presentation.

In order to realize the augmentation of a digital user experience, a reference patch can be used. In one embodiment, the reference patch or other visually detectable element may serve to indicate a position at which digital content is to be placed onto a display. In some embodiments and as described herein, the reference patch can include encoded information that can be used to retrieve digital content and place that digital content into a desired location or locations in displayed data. The digital content can include at least one digital object. The reference patch can be embedded within displayed data (such as, but not limited to, an image, a video, a document, a webpage, or any other application that may be displayed by an electronic device). The reference patch can include unique identifying data in the form of a unique identifier, a marker, or encoding corresponding to predetermined digital content. The reference patch can indicate to the electronic device the particular digital content that is to be displayed, the position at which the digital content is to be placed, and the size with which the digital content is to be displayed. Accordingly, when a portion of displayed data comprising the reference patch is visible, a corresponding augmentation can be overlaid on the current frame of the displayed data wherein the augmentation includes secondary digital content (i.e., content that is secondary to (or comes after) the primary displayed data), herein referred to as “digital content,” and/or digital objects. For example, an augmentation can include additional images to be displayed with the current frame of displayed data for a seamless visual experience.

In an embodiment, a window containing a portion of the displayed data (e.g., word processing document) to be augmented can provide a region, or a surface area, for augmentation resulting from an identified reference patch within the displayed data. The window may thereby function as an anchor for the digital content, indicating where digital content can be relatively arranged. In an embodiment, digital content can be realized within a viewable area of a device software application or may reside within an entire viewable display area of the display. For instance, if a user is viewing a portable document format (PDF) document, a reference patch corresponding to given digital content may be within a viewable area of the PDF document and the digital content can be generated in a corresponding window through which the PDF document is being viewed. Additionally or alternatively, the digital content can be generated within the entire viewable display area of the display and may not reside only within the corresponding window through which the PDF document is being viewed.

The above-described augmentations are particularly relevant to environments where the underlying content is static. Static content may include textual documents or slide decks. Often, the static content is stored locally in the electronic device. Due to its nature, the static content is not capable of being dynamically adjusted according to complex user interactions, in real-time, during a user experience. Such a digital user experience is cumbersome and inefficient. Thus, a heightened, augmented user experience is desired to provide increased convenience, engagement, and agility. The augmentations described herein reduce cumbrousness by providing a visual representation/aid of retrieved external digital content, and provide improved engagement of the user, agility of navigation through the displayed data, and overall performance of the user device.

Described herein is a device and method to incorporate a reference patch with encoded identifier attributes, where the reference patch serves as a conduit for delivering content into the displayed data.

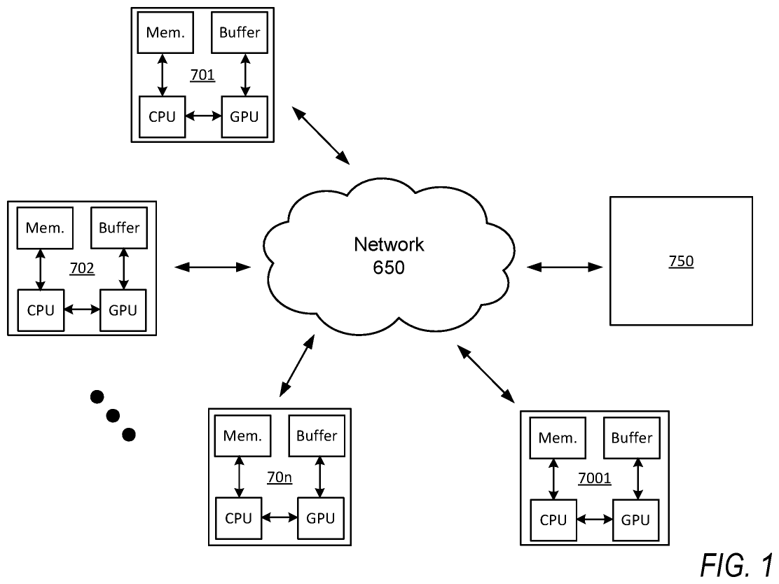

FIG. 1 is a schematic view of an electronic device, such as a client/user device (a first device 701) communicatively connected, via a network 650, to a second electronic device, such as a server (a networked device 750), and a generating device 7001, according to an embodiment of the present disclosure. Further, in an embodiment, additional client/user devices can be communicatively connected to both the first device 701 and the networked device 750. A second client/user device 702 can be communicatively connected to the first device 701 and the networked device 750. As shown, the client/user devices can be communicatively connected to, for example, an nth user device 70n. The devices can be connected via a wired or a wireless network. In one embodiment, the first device 701 can be responsible for transmitting displayed data over the communication network 650 to the second client/user device 702 and/or the nth user device 70n.

An application may be installed or accessible on the first device 701 for executing the methods described herein. The application may also be integrated into the operating system (OS) of the first device 701. The first device 701 can be any electronic device such as, but not limited to, a personal computer, a tablet pc, a smart-phone, a smart-watch, an integrated AR/VR (Augmented Reality/Virtual Reality) headwear with the necessary computing and computer vision components installed (e.g., a central processing unit (CPU), a graphics processing unit (GPU), integrated graphics on the CPU, etc.), a smart-television, an interactive screen, a smart projector or a projected platform, an IoT (Internet of things) device or the like.

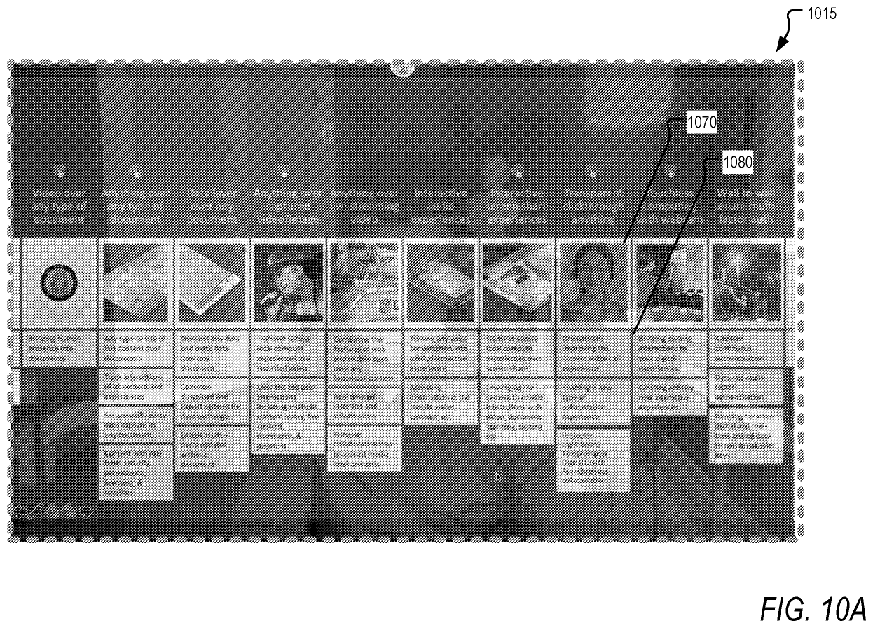

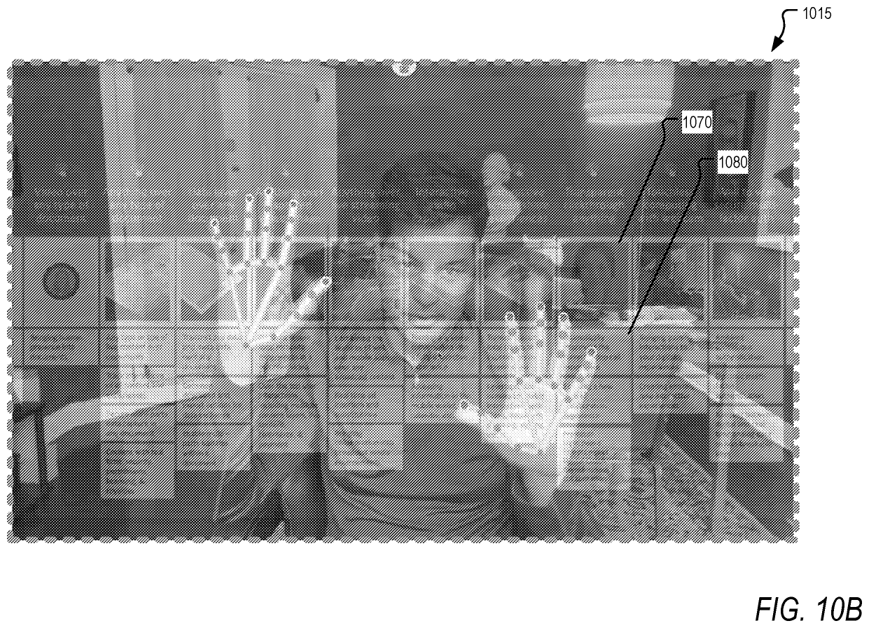

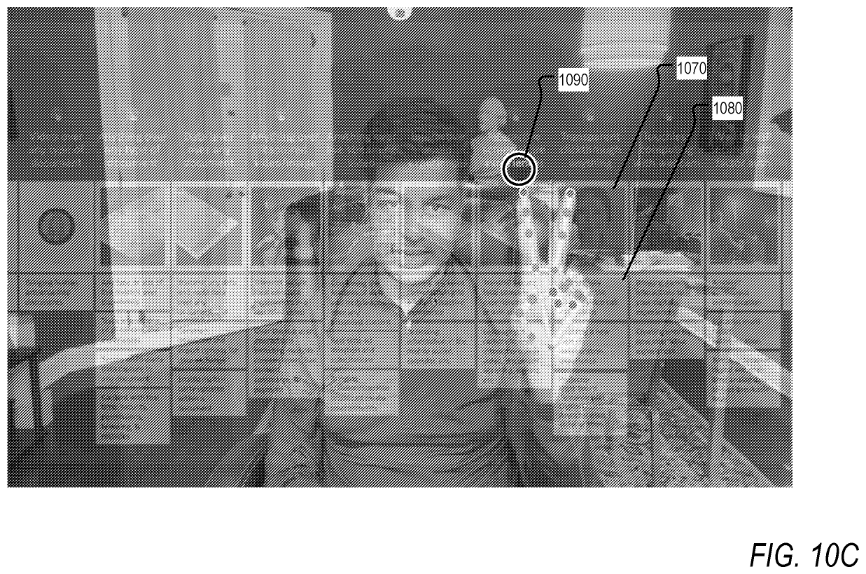

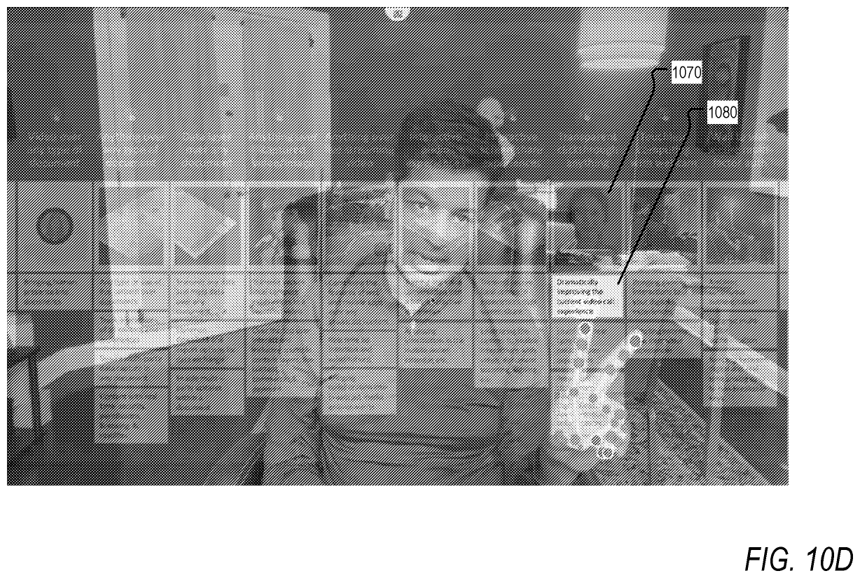

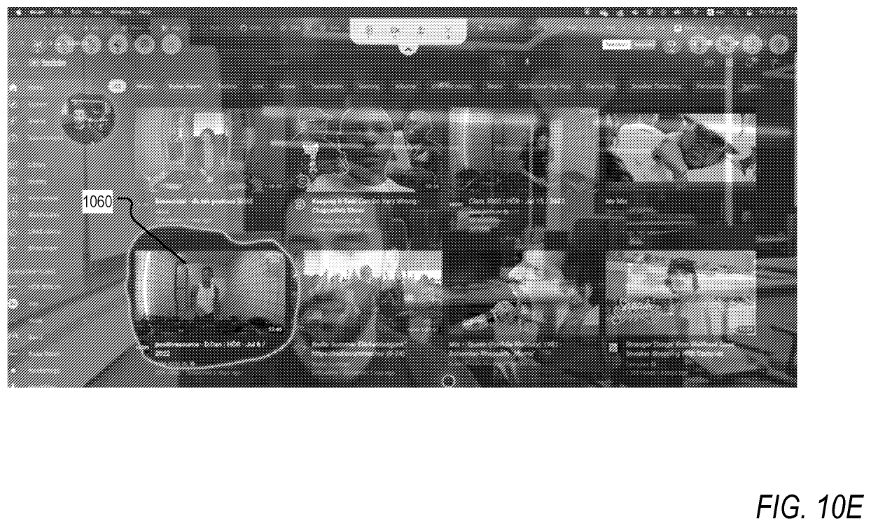

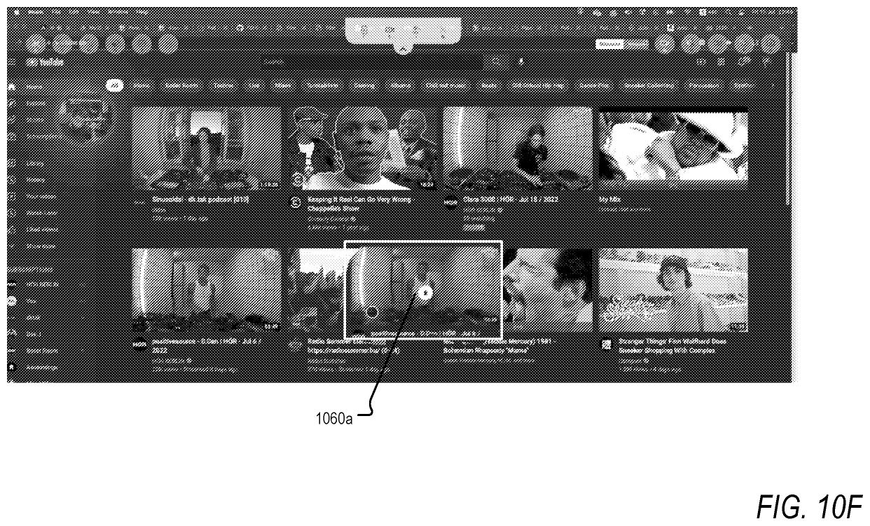

As illustrated in FIG. 1, the first device 701 includes a CPU, a GPU, a main memory, and a frame buffer, among other components (discussed in more detail in FIGS. 10-12). In an embodiment, the first device 701 can call graphics that are displayed on a display. The graphics of the first device 701 can be processed by the GPU and rendered in frames stored on the frame buffer that is coupled to the display. In an embodiment, the first device 701 can run software applications or programs that are displayed on a display. In order for the software applications to be executed by the CPU, they can be loaded into the main memory, which can be faster than a secondary storage, such as a hard disk drive or a solid state drive, in terms of access time. The main memory can be, for example, random access memory (RAM) and is physical memory that is the primary internal memory for the first device 701. The CPU can have an associated CPU memory and the GPU can have an associated video or GPU memory. The frame buffer can be an allocated area of the video memory. It can be understood that the CPU may have multiple cores or may itself be one of multiple processing cores in the first device 701. The CPU can execute commands in a CPU programming language such as C++. The GPU can execute commands in a GPU programming language such as HLSL. The GPU may also include multiple cores that are specialized for graphic processing tasks. Although the above description was discussed with respect to the first device 701, it is to be understood that the same description applies to the other devices (702, 70n, and 7001) of FIG. 1. Although not illustrated in FIG. 1, the networked device 750 can also include a CPU, GPU, main memory, and frame buffer.

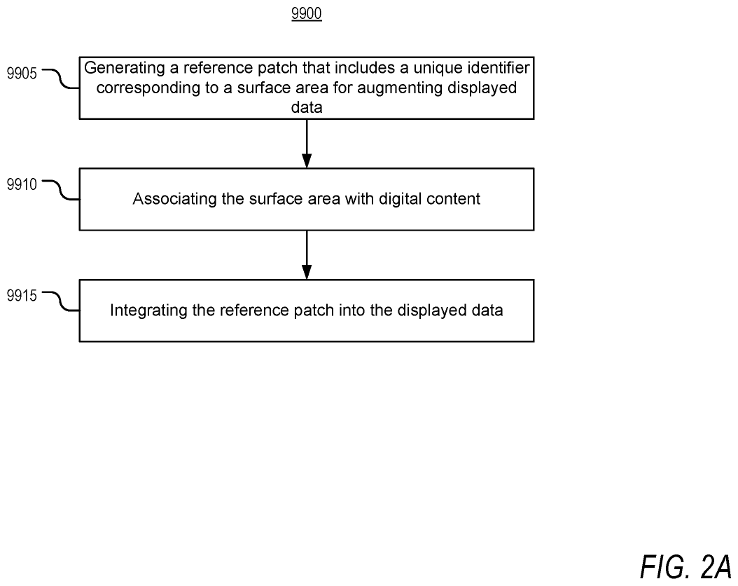

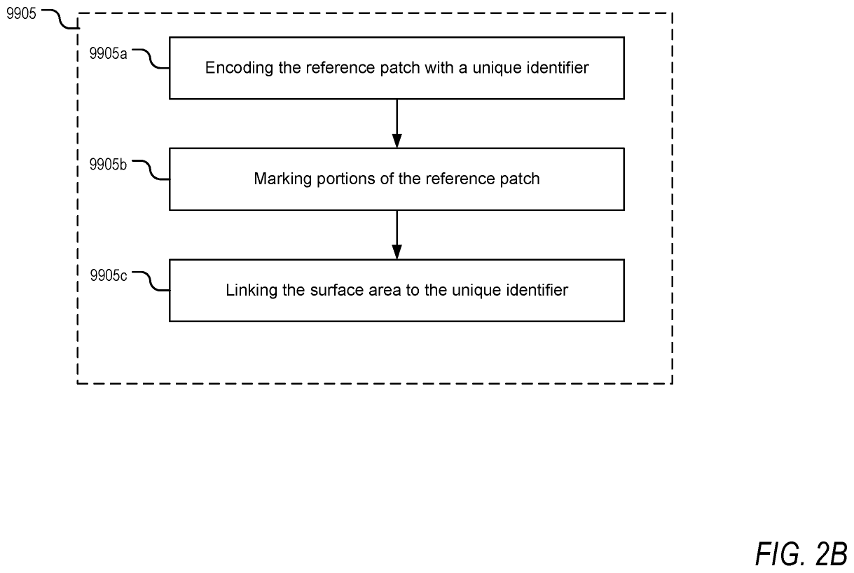

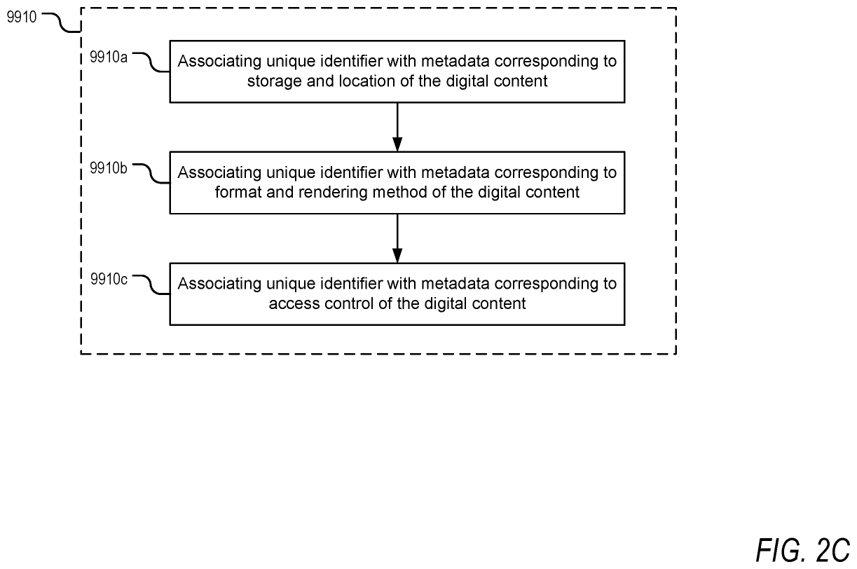

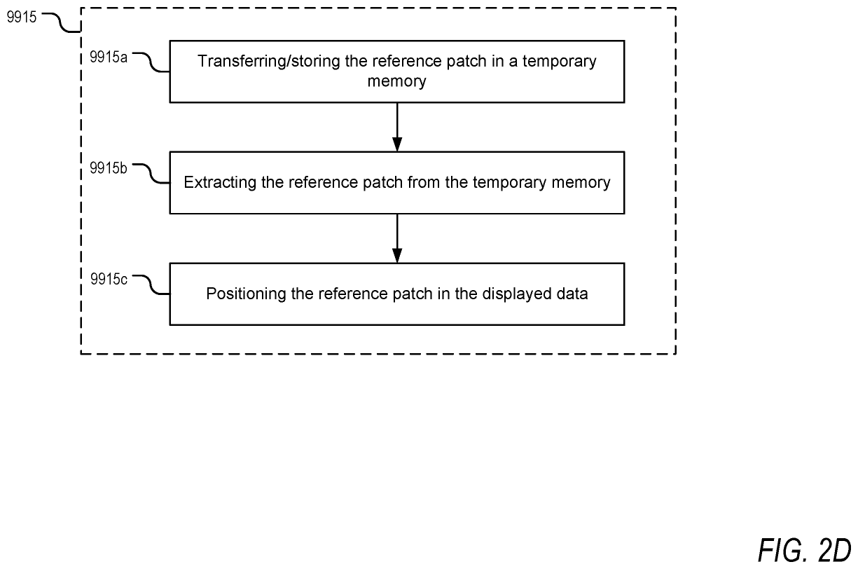

FIG. 2A is a flow chart for a method 9900 for generating a reference patch and embedding the reference patch into displayed data according to one embodiment of the present disclosure. The present disclosure describes generation of the reference patch and embedding of this patch into the displayed data content in order to integrate additional content. In an embodiment, the first device 701 can incorporate (secondary) digital content into what is already being displayed (displayed data) for a more immersive experience.

In this regard, the first device 701 can generate the reference patch in step 9905. The reference patch can be an object having an area and shape that is embedded in the displayed data at a predetermined location. For example, the reference patch can be a square overlayed and disposed in a corner of a digital document (an example of displayed data), wherein the reference patch can be fixed to a predetermined page for a multi-page (or multi-slide) digital document. The reference patch can thus also represent a surface area in the digital document. The reference patch can be an object that, when not in a field of view of the user, is inactive. The reference patch can, upon entering the field of view of the user, become active. For example, the reference patch can become active when detected by the first device 701 in the displayed data. When active, the reference patch can enable the first device 701 to retrieve digital content and augment the displayed data by incorporating the retrieved digital content into the displayed data. Alternatively, the reference patch can become active when located within the frame of the screen outputting the displayed data. For example, even if another window or popup is placed over top of the reference patch, the reference patch may continue to be active so long as the reference patch remains in the same location after detection and the window including the document incorporating the reference patch is not minimized or closed. As will be described further below, the reference patch can have a predetermined design that can be read by the first device 701, leading to the retrieval and displaying of the digital content.

In an embodiment, the first device 701 can use a geometrical shape for the reference patch and place the reference patch into displayed data using applications executed in the first device 701. The reference patch can take any shape such as a circle, square, rectangle or any arbitrary shape. In step 9910, the reference patch can also have predetermined areas within its shape for including predetermined data. The predetermined data can be, for example, unique identifiers that correspond to a surface area of the displayed data. In one embodiment, the unique identifier can include encoded data that identifies the digital content, a location address of the digital content (e.g., at the networked device 750), a screen position within the surface area at which the digital content is insertable in the displayed data, and a size of the digital content when inserted in the displayed data (adjustable before being displayed). In one embodiment, the unique identifier can include a marker. As will be described below, the marker can take the form of patterns, shapes, pixel arrangements, pixel luma, and pixel chroma, among others. Digital content can be displayed at the surface areas, or locations in the displayed data, corresponding to the unique identifier. In one embodiment, the surface areas are reference points for the relative location of digital content. In one embodiment, surface area refers to empty space wherein additional digital content can be inserted without obscuring displayed data. In one embodiment, the designation of empty space prioritizes preserving visibility of the reference patch.

For example, the first device 701 can use computer vision (described below) to detect displayed data. For example, the first device 701 can inspect an array to determine locations of objects in the displayed data. For example, a slide in a slide deck can include text, pictures, logos, and other media, and the surface area is the blank space or spaces around the aforementioned objects. Thus, the digital content can be displayed somewhere in the blank spaces. In an embodiment, the surface area of the displayed data can include portions of the displayed data that already include objects and the digital content can be displayed at the same location as the objects. For example, a slide in a slide deck can include a picture of a user, and the reference patch can be the area representing a face of the user and the additional digital content can be displayed at the same location as a body of the user. In another example, a slide in a slide deck can include an image of a vehicle wherein the image of the vehicle is the surface area for the digital content. The reference patch can be disposed in a blank space of the displayed data, and digital content retrieved (e.g., images of a new car paint color and new rims) as a result of the reference patch is displayed over the image of the vehicle to modify the appearance of the vehicle. In other words, the digital content may be placed in a blank area of the displayed data and/or in an area that is not blank (i.e., an area that includes text, image(s), video(s), etc.).

In step 9915, the first device 701 can embed the reference patch into the displayed data, such as a word processing document file (i.e., DOC/DOCX) provided by e.g., Microsoft® Word, in a Portable Document Format (PDF) file such as the ones used by Adobe Acrobat®, in a Microsoft® PowerPoint presentation (PPT/PPTX), or in a video sequence file such as MPEG, MOV, AVI or the like. These file formats are illustrative of some file types which a user may be familiar with; however, applications included in the first device 701 are not limited to these types and other applications and their associated file types are possible.

The reference patch (or similar element) can be embedded into any displayed data, where the displayed data may be generated by an application running on or being executed by the first device 701. The reference patch can encompass the whole area designated by the displayed data, or just a portion of the area designated by the displayed data. The method of generating the reference patch and embedding the reference patch into the displayed data has been described as being performed by the first device 701, however, the networked device 750 can instead perform the same functions. In order to be detected in the displayed data on the first device 701, the reference patch may only be simply displayed as an image on the screen. The reference patch may also simply be a raster image or in the background of an image. The reference patch is also able to be read even when the image containing the reference patch is low resolution. The reference patch can be encoded in a hardy and enduring manner such that even if a portion of the reference patch is corrupted or undecipherable, the reference patch can still be activated and used.

In an embodiment, the reference patch can be embedded inside of a body of an email correspondence. The user can use any electronic mail application such as Microsoft Outlook®, Gmail®, Yahoo®, etcetera. As the application is running on the first device 701, it allows the user to interact with other applications. In an embodiment, the reference patch can be embedded on a video streaming or two-way communication interface such as a Skype® video call or a Zoom® video call, among others. In an embodiment, the reference patch can be embedded in displayed data for multi-party communication on a live streaming interface such as Twitch®.

One way in which the first device 701 can embed the reference patch into the displayed data is by arranging the generated reference patch in the displayed data such as in a desired document or other media. The reference patch can include a facade of the digital content which becomes an integrated part of the displayed data. The facade can act as a visual preview to inform the user of the digital content linked to the reference patch. The facade can include, for example, a screenshot of a video to be played, a logo, an animation, or an image thumbnail, among others. In one embodiment, the facade can be an altered version of the digital content. For example, the facade is a more transparent version of the digital content. The facade can be a design overlay. The design overlay can be a picture that represents the digital content superimposed over the reference patch. In an embodiment, the facade can indicate the content that is represented by the reference patch. The facade can be contained within the shape of the reference patch or have a dynamic size. For example, attention of the user can be brought to the facade by adjusting the size of the facade when the reference patch is displayed. The adjustment of the size of the facade can also be dynamic, wherein the facade can enlarge and shrink multiple times. By the same token, a position and/or a rotation of the facade can also be adjusted to produce a shaking or spinning effect, for instance.

Unlike traditional means of sending displayed data, in one embodiment the first device 701 may not send the whole digital content with a header file (metadata) and a payload (data). Instead, the reference patch that may include a facade of the underlying digital content is placed within the displayed data. If a facade is present, it indicates to the first device 701 that the surface area can have digital content that can be accessed with selection (clicking with a mouse, touchpad, eye contact, eye blinks, or via voice command) of the facade. The digital content can also be accessed or activated automatically, e.g., when the reference patch is displayed on the display of the first device 701. Other means of visualization can be employed to indicate to the user that the surface area is likely to include information for obtaining digital content. For example, a highlighting effect can be applied along a perimeter of the reference patch with varying intensity to bring attention to the presence of the reference patch. As another example, dashed lines perpendicular to the perimeter of the reference patch can appear and disappear to provide a flashing effect. Other means can be employed to indicate to the user that the surface area is likely to include information for obtaining digital content, such as an audio cue.

The first device 701 employs further processes before embedding the reference patch into the displayed data. These processes and schemas are further discussed in FIG. 2B. FIG. 2B is a flow chart of a sub-method 9905 of generating the reference patch, according to an embodiment of the present disclosure. The first device 701 can associate the digital content with the surface area corresponding to the reference patch (e.g., via the unique identifiers included therein) generated by the first device 701. In an embodiment, the surface area may encompass the whole of the displayed data or a portion of it. The reference patch, which includes the unique identifiers corresponding to the surface area associated with the digital content, is then embedded into the displayed data by the first device 701. In some use cases, the displayed data including the reference patch can be sent or transmitted to the second client/user device 702 including the same application, which then allows the second client/user device 702 to access information within the surface area and obtain the digital content for display. That is, the second client/user device 702 can overlay the augmenting digital content on the displayed data on the display of the second client/user device 702 in the location or locations (surface areas) defined by the reference patch.

In FIG. 2B, the generating device 7001 uses additional processes to generate the reference patch, which is obtained and embedded by the first device 701. In an embodiment, the generating device 7001 encodes the reference patch with the unique identifiers corresponding to the surface area in step 9905a. The generating device 7001 can mark areas of the reference patch in step 9905b to form a marker. The marker can take the form of patterns, shapes, pixel arrangements, or the like. In an example, the marker can have a shape that corresponds to the shape of the surface area. In an example, the marker can have a size that corresponds to the size of the surface area. In an example, the marker can have a perimeter that corresponds to the perimeter of the surface area. The marker can use any feasible schema to provide identifying information that corresponds to the surface area within the displayed data. In an embodiment, the marker can incorporate hidden watermarks that are only detectable by the first device 701, which has detection functionality implemented therein, for example having an application installed or the functionality built into the operating system. The generating device 7001 can further link the surface area with unique identifiers in step 9905c. A unique identifier can be used to define or reference a surface area on the display. In one embodiment, the unique identifiers are used to set the content, position, sizing, and/or other visual properties of augmenting digital content. The unique identifiers can be hashed values (such as those described above) that are generated by the generating device 7001 when the reference patch is generated (such as the one having the area of the reference patch divided into the subset of squares).

The marker can incorporate patterns which can then be extracted by the first device 701. In an example, the first device 701 can perform the embedding, then send the displayed data having the embedded reference patch to the second client/user device 702. The encoding can be performed by the generating device 7001 and may use any variety of encoding technologies, such as those used to generate ArUco markers, to encode the reference patch by marking the reference patch with the marker. The first device 701 may also be used as the generating device 7001. In one embodiment, the networked device 750, the second client/user device 702, and/or the nth client/user device 70n can obtain, embed, and/or detect the reference patch from the generating device 7001.

In an embodiment, the marker can be comprised of a set of points. In one embodiment, the set of points can be equidistant from each other and/or make up equal angles when measured from a reference point, such as the center of the reference patch. That is, the fiducial points corresponding to the marker can provide a set of fixed coordinates or landmarks within the displayed data with which the surface area can be mapped. In an embodiment, the marker can be comprised of a set of unique shapes, wherein combinations of the unique shapes can correspond to a target surface area (or available area, or areas) for displaying the displayed data. The combinations of the unique shapes can also correspond to digital content for displaying in the surface area. The combinations of the unique shapes can also correspond to/indicate a position/location where the digital content should be displayed at the surface area relative to a portion of the surface area and/or the displayed data. A combination of the set of points and unique identifiers can be used as well. In one embodiment, pixel coordinates of the reference patch can be determined, and the objects can be displayed relative to the pixel coordinates of the reference patch.

For example, the unique identifiers can be unique shapes that correlate to digital content as well as indicating where the digital content should be overlayed on the display (the screen position). In one embodiment, the position of the digital content is determined relative to a set of points marked on the reference patch. The unique identifiers can also indicate a size of the digital content to be overlayed on the display, which can be adjustable based on the size of the surface area (also adjustable) and/or the size of the display of the first device 701. The unique identifiers can be relatively invisible or undetectable to the user, but readable by the first device 701 and cover predetermined areas of the reference patch. The unique identifiers, and by extension, the marker, can have an appearance that is different from an appearance of the area of the reference patch. In one embodiment, the unique identifiers use metamers or other visual effects such that the difference between the unique identifiers and the reference patch is only fully discernible by an electronic device. For example, the area of the reference patch can appear white to the user and the unique identifiers can also appear white to the user but may actually have a slightly darker pixel color that can be detected and interpreted by a device, such as the first device 701. In another example, the appearance of the unique identifiers can be 0.75% darker than the white color of the area of the reference patch. Such a small difference can be identified and discerned by the first device 701 while being substantially imperceptible to the user.

In an embodiment, the area of the reference patch can be divided into sections, for instance a set of squares, wherein a marker is included within each square. An example of a marker includes a letter. For example, a reference patch is divided into 16 squares, wherein each square is designated to represent different information, e.g., a timestamp, a domain, a version. Thus, the marker in each square is interpreted according to the designation of that square. An identification based on the set of squares can be, for example, an 18-character (or “letter”) hexadecimal. The set of squares can further include additional subsets for a randomization factor, which can be used for calculating a sha256 hash prior to encoding the reference patch with the hash. Together, the set of squares having the marker included therein can comprise the unique identifiers.

Moreover, the generating device 7001 can also employ chroma subsampling to mark the reference patch with attributes represented by a particular pattern. In an embodiment, the generating device 7001 can mark parts of the reference patch with predetermined patterns of pixel luma and chroma manipulation that represent a shape, a size, or a position of the surface area for displaying the digital content. In one embodiment, the generating device 7001 can mark a perimeter of the reference patch with a predetermined edging pattern of pixel luma and chroma manipulation that represents a perimeter of the surface area for displaying the digital content.

FIG. 2C is a flow chart of a sub-method of associating the surface area with digital content, according to an embodiment of the present disclosure. In FIG. 2C, the generating device 7001 uses additional processes to associate the surface area with digital content. In an embodiment, the generating device 7001 can associate the unique identifiers corresponding to the surface area with metadata. In step 9910a, the unique identifiers can be associated with metadata embodying information about the storage and location of the digital content. In step 9910b, the generating device 7001 can associate the unique identifier of the surface area with metadata which embodies information about the format and rendering information used for the digital content. In step 9910c, the generating device 7001 can associate the unique identifiers of the surface area with metadata which embodies access control information to the digital content.

In an embodiment, the storage of the digital content can be on a remote server, such as the networked device 750, and the location of the digital content can be the location address of the memory upon which it is stored at the remote server. The storage and location of the digital content can thus be linked with the metadata and/or the unique identifier wherein the metadata and/or the unique identifier point to how a device can obtain the digital content. The digital content is thus not directly embedded into the displayed data. In an embodiment, the format and rendering information about the digital content can be embodied in the metadata and associated with the unique identifiers. This information is helpful when the first device 701 or the second client/user device 702 are on the receiving end of the transmitted displayed data and need to properly retrieve and process the digital content.

Moreover, in an embodiment, the access control of the digital content can also be encompassed in the metadata and associated with the unique identifiers corresponding to the surface area. The access control can be information defining whether the digital content can be accessed by certain devices or users. In one embodiment, the access control is restricted by geographical location, time, date, device type, display type, software version, and/or operating system version. For example, a user may wish to restrict access to the digital content to certain types of devices, such as smartphone or tablets. Thus, the metadata defining a display requirement would encompass such an access control parameter. In one embodiment, the access control further includes how long a device can access the digital content, sharing settings, and/or password protection of the digital content.

FIG. 2D is a flow chart of a sub-method 9915 for integrating the reference patch into the displayed data, according to an embodiment of the present disclosure. In an embodiment, the generating device 7001 can temporarily transfer to or store the reference patch in a storage of the first device 701 in step 9915a. The storage can be accessed by the first device 701 for embedding the reference patch into the displayed data at any time. The first device 701 can extract the reference patch from the storage for embedding purposes in step 9915b. The first device 701 can also arrange the reference patch at a predetermined location and with a predetermined reference patch size in step 9915c. The first device 701 can further embed the reference patch such that a document, for example, having the reference patch embedded therein can be sent to a recipient, for example the second client/user device 702, where the second client/user device 702 can access the document using an application. Note that the features of the generating device 7001 can be performed by the first device 701.

The displayed data can be output from a streaming application or a communication application with a data stream having the reference patch embedded therein. The actual digital content may not be sent along with the underlying displayed data or data stream, but only the reference patch, the unique identifier, and/or a facade of the digital content is sent. In one embodiment, the unique identifier and/or the metadata can be stored in a database such as MySQL which can point to the networked device 750 or a cloud-based file hosting platform that houses the digital content. No limitation is to be taken with the order of the operation discussed herein; such that the sub-methods performed by the first device 701 can be carried out synchronous to one another, asynchronous, dependently or independently of one another, or in any combination. These stages can also be carried out in series or in parallel fashion.

There can be many ways to identify a reference patch within a frame of displayed data. In one embodiment, the displayed data can be stored in a frame buffer. A frame buffer is a segment of memory that stores pixel data as a bitmap, or an array of bits. Each pixel in the display is defined by a color value. The color value is stored in bits. In one embodiment, the frame buffer can include a color lookup table, wherein each pixel color value is an index that references a color on the lookup table. A frame buffer can store a single frame of displayed data or multiple frames of displayed data. In order to store multiple frames of displayed data, the frame buffer includes a first buffer and at least one additional buffer. A currently displayed frame of displayed data is stored in the first buffer, while at least one subsequent frame is stored in the at least one additional buffer. When the subsequent frame is displayed, the first buffer is then filled with new displayed data. Frame buffers can be stored in a graphics processing unit (GPU). In one embodiment, each of the second electronic devices (e.g., the first device 701, the second client/user device 702, the nth user device 70n) can access the frame buffer in the GPU and analyze the pixel data in order to identify a reference patch.

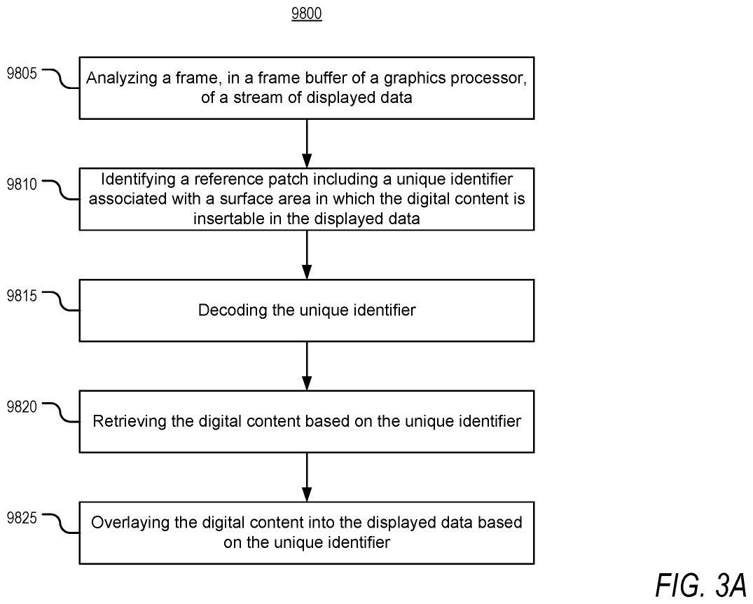

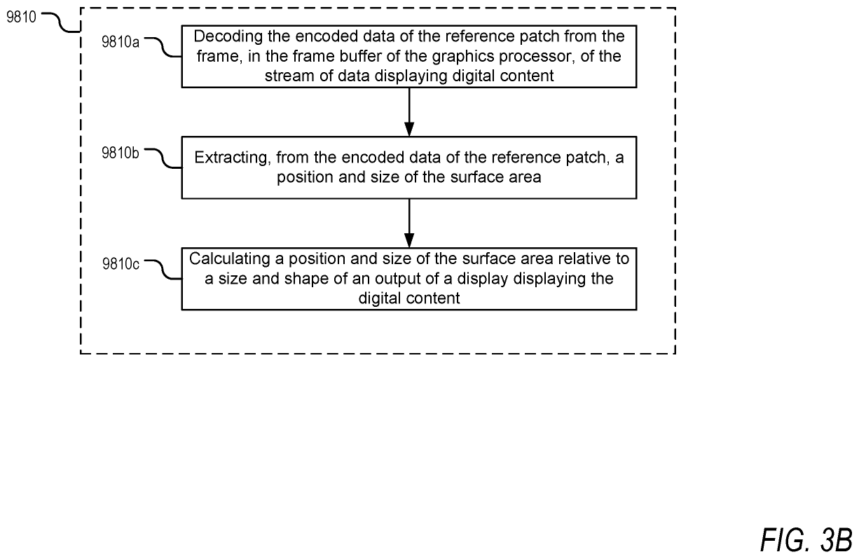

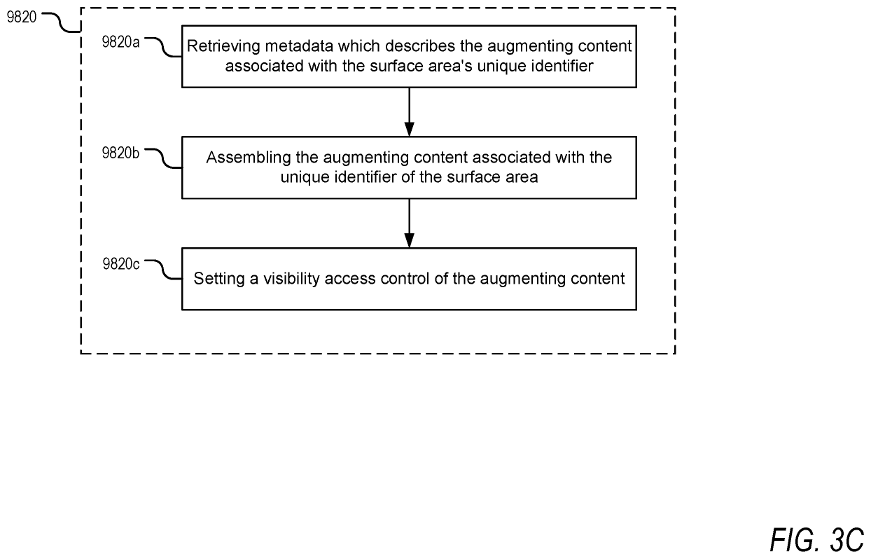

FIG. 3A is a flow chart for a method 9800 of identifying the reference patch included in the displayed data and overlaying the digital content onto displayed data according to an embodiment of the present disclosure. In an embodiment, in step 9805, the first device 701 can inspect the stream of data being outputted by the first device's 701 video or graphics card and onto the display of the first device 701. That is, the first device 701 can access a frame buffer of the GPU and analyze, frame by frame, in the frame buffer, the outputted stream of data which can include the displayed data. In an embodiment, a frame represents a section of the stream of the displayed data that is being displayed by the first device 701. In that regard, the first device 701 can inspect the outputted stream of data. The first device 701 can achieve this by intercepting and capturing data produced from the first device 701's video card or GPU that is communicated to the first device 701's display. Inspecting the frame buffer is a method for visually identifying the reference patch as part of the display content.

In an embodiment, in step 9810, the first device 701 can process attributes of each pixel included in a single frame and detect groups of pixels within that frame with a known predetermined pattern of pixel luma and chroma manipulation in order to find the reference patch. In one embodiment, the first device 701 can identify the reference patch based on a confidence level for a predetermined pattern of pixel luma and chroma manipulation and/or a predetermined edge pattern of pixel luma and chroma manipulation. For example, the first device 701 can identify a reference patch wherein the reference patch is a uniform gray rectangle surrounded by a white background. The pattern of chroma manipulation of gray rectangle in contrast with the surrounding pixel data is identifiable as a reference patch. In another embodiment, the first device 701 can identify a line segment separating a reference patch from the remainder of the displayed data based on the color and/or brightness of the line segment. In one embodiment, the first device 701 can inspect pixels in batches. In one embodiment, identifying the reference patch is done by inspecting the frame buffer using computer vision, including, but not limited to, image recognition, semantic segmentation, edge detection, pattern detection, object detection, image classification, and/or feature recognition. Examples of artificial intelligence computing systems and techniques used for computer vision include, but are not limited to, artificial neural networks (ANNs), generative adversarial networks (GANs), convolutional neural networks (CNNs), thresholding, and support vector machines (SVMs). Computer vision is useful when the displayed data includes complex imagery and/or when the reference patch would otherwise blend into the displayed data. For example, an image of a car is a reference patch, and the displayed data includes multiple images of cars. Computer vision enables the first device 701 to accurately identify the specific image of the car that is the reference patch in the displayed data.

In a non-limiting example, the processor-based computer vision operation can include sequences of filtering operations, with each sequential filtering stage acting upon the output of the previous filtering stage. For instance, when the processor is a graphics processing unit (GPU), these filtering operations are carried out by fragment programs. In the event an input to the operation is an image, the input images are initialized as textures and then mapped onto quadrilaterals. Displaying the input in quadrilaterals ensures a one-to-one correspondence of image pixels to output fragments. Similarly, when the input to the operation is an encoded image, a decoding process may be integrated into the processing steps described above. A complete computer vision algorithm can be created by implementing sequences of these filtering operations. After the texture has been filtered by the fragment program, the resulting image is placed into texture memory, either by using render-to-texture extensions or by copying the frame buffer into texture memory. In this way, the output image becomes the input texture to the next fragment program. This creates a pipeline that runs the entire computer vision algorithm. However, often a complete computer vision algorithm will require operations beyond filtering. For example, summations are common operations. Furthermore, more-generalized calculations, such as feature tracking, can also be mapped effectively onto graphics hardware.

In an embodiment, the reference patch can be identified by use of edge detection methods. In an example, the edge detection method may be a Canny edge detector. The Canny edge detector may be run on the GPU. In one instance, the Canny edge detector can be implemented as a series of fragment programs, each perform a step of the algorithm.

In an embodiment, the identified reference patch can be tracked from frame to frame using feature vectors. Calculating feature vectors at detected feature points is a common operation in computer vision. A feature in an image is a local area around a point with some higher-than-average amount of “uniqueness.” This makes the point easier to recognize in subsequent frames of video. The uniqueness of the point is characterized by computing a feature vector for each feature point. Feature vectors can be used to recognize the same point in different images and can be extended to more generalized object recognition techniques.

Feature detection can be achieved using methods similar to the Canny edge detector that instead search for corners rather than lines. If the feature points are being detected using sequences of filtering, the GPU can perform the filtering and read back to the central processing unit (CPU) a buffer that flags which pixels are feature points. The CPU can then quickly scan the buffer to locate each of the feature points, creating a list of image locations at which the feature vectors will be calculated on the GPU.

In step 9815, the first device 701 can decode the encoded unique identifier included with the reference patch wherein the unique identifier corresponds to a surface area for augmentation. In one embodiment, a reference patch can include one or more unique identifiers. In one embodiment, the unique identifier can be a hashed value. In one embodiment, the unique identifier was generated by the first device 701. In one embodiment, the unique identifier was generated by an external device, e.g., the networked device 750, the second client/user device 702, the nth user device 70n.

In step 9820, the first device 701 uses the unique identifier to retrieve digital content. In one embodiment, the unique identifier describes the content, the location address, metadata, or other identifying information about the digital content. In one embodiment, the first device 701 retrieves the digital content from a server, e.g., the networked device 750. In one embodiment, the first device 701 retrieves the digital content from main memory.

In step 9825, the first device 701 overlays digital content as an augmentation of the displayed data. In one embodiment, the location of the digital content is the surface area described by the unique identifier. The digital content is overlaid as an additional layer to the displayed data. Although the digital content is visually merged with the displayed data, the data itself is isolated from the displayed data and can be modified independently of the rest of the displayed data.

Again, the method of identifying the reference patch included in the displayed data and augmenting the displayed data is described as performed by the first device 701, however, the networked device 750 can instead perform the same functions.

In an embodiment, the first device 701 identifies the surface area corresponding to the reference patch by employing further processes to process the frames. To this end, FIG. 3B is a flow chart of a sub-method of identifying the reference patch with the unique identifiers corresponding to the surface area from the stream of data, according to an embodiment of the present disclosure.

In step 9810a, the first device 701 can decode the encoded reference patch from the frame. The encoded reference patch can include the marker that makes up the unique identifiers within the reference patch incorporated previously. The reference patch can also include other identifying information. The marker can be disposed within the reference patch, such as within the area of the reference patch or along a perimeter of the reference patch, or alternatively, outside of the area of the reference patch.

Whatever schema is used to encode the marker in the reference patch is also used in reverse operation to decode the underlying information contained within the reference patch. As stated above, in an embodiment, the encoded marker can be patterns generated and decoded using the ArUco algorithm or by other algorithms that encode data according to a predetermined approach.

In step 9810b, the first device 701 can also extract attributes of the surface area from the reference patch. In an embodiment, the position, size, shape, and perimeter of the surface area are extracted, although other parameters can be extracted as well. Other parameters include boundary lines, area, angle, depth of field, distance, ratio of pairs of points, or the like. In an embodiment, where shape and perimeter are designated as the attributes, the first device 701 makes determinations of size, shape, and perimeter and outputs that result. Specifically, the size or shape of the surface area can be determined by evaluating a predetermined or repeatable pattern of pixel luma and chroma manipulation in the reference patch. The predetermined pattern can be marked on, within the area, or outside of the area of the reference patch. The predetermined pattern can correspond to the size or shape of the surface area. The predetermined pattern can correspond to the size or shape of the digital content. The perimeter of the surface area can also be determined by evaluating a predetermined edging pattern of pixel luma and chroma manipulation. The predetermined edging pattern can be marked on, within the area, or outside of the area of the reference patch. That is, the predetermined edging pattern of the reference patch can correspond to the perimeter of the surface area. The predetermined edging pattern of the reference patch can correspond to the perimeter of the digital content.

In step 9810c, the first device 701 can also calculate a position and size of the surface area relative to the size and shape (dimensions) of the output signal from the display that is displaying the displayed data. In an embodiment, the calculating of the size, relative to the size and shape of the outputted signal from the display, includes determining the size of the surface area by inspecting a furthest measured distance between the edges of the surface area. Furthermore, the calculating of a location of the surface area, relative to the size and shape of the outputted signal from the display, includes determining the location of the surface area relative to the size and shape of the displayed data outputted through the display. This includes calculating the distance between the outer edges of the surface area and the inner edges of the displayed data being outputted by the display. The determined size and location of the surface area can be outputted as a result. Notably, prior to overlaying the digital content into the displayed data, the first device 701 can adjust, based on the predetermined pattern and the predetermined edging pattern, the size and perimeter of the digital content for displaying in the display of the first device 701. For example, the size and perimeter of the digital content for displaying in the display of the first device 701 can be scaled based on the size and perimeter of the surface area and/or the size of the display.

The first device 701 can provide information regarding the characteristics of the output video signal, such that the digital content that is later overlaid can correctly be displayed to account for various manipulations or transformations that may take place due to hardware constraints, user interaction, image degradation, or application intervention. Such manipulations and transformations may be the relocation, resizing, and scaling of the reference patch and/or the surface area, although the manipulations and transformations are not limited to those enumerated herein.

In an embodiment, the reference patch itself can be used as the reference for which the digital content is displayed on the surface area. In one example, the location at which to display the digital content in the surface area can be determined relative to the location of the reference patch on the displayed data. In one example, the size of the surface area can be determined relative to the size of the reference patch on the displayed data. In an example employing a combination of the two properties of the reference patch, the reference patch displayed in the displayed data on a smart phone having a predetermined size and a surface area can be scaled relative to the predetermined size of the display of the smart phone. This can be further adjusted when the reference patch in the same displayed data is displayed on a desktop monitor, such that the predetermined size of the reference patch in the displayed data displayed on the desktop monitor is larger and thus the size of the surface area can be scaled to be larger as well. Furthermore, the location of the surface area can be determined via a function of the predetermined size of the reference patch. For example, the location at which to display the digital content in the surface area can be disposed some multiple widths laterally away from the location of the reference patch as well as some multiple heights longitudinally away from the location of the reference patch. As such, the predetermined size of the reference patch can be a function of the size of the display of the first device 701. For example, the predetermined size of the reference patch can be a percentage of the width and height of the display, and thus the location and the size of the surface area are also a function of the width and height of the display of the first device 701.

In an embodiment, the first device 701 can determine an alternative location at which to display the digital content based on behaviors of the user. For example, the first device 701 can compare the encoded data corresponding to the location at which to display the digital content in the surface area to training data describing movement and focus of the user's eyes while viewing the displayed data. Upon determining the location at which to display the digital content in the surface area (as encoded in the reference patch) is not the same as the training data, the first device 701 can instead display the digital content at the location described by the training data as being where the user's eyes are focused in the displayed data at a particular time. For example, the user's eyes may be predisposed to viewing a bottom-right of a slide in a slide deck. The first device 701 can decode the reference patch and determine the digital content is to be displayed in a bottom-left of the slide deck. The training data can indicate that, for example, the user's eyes only focus on the bottom-left of the slide 10% of the time, while user's eyes focus on the bottom-right of the slide 75% of the time. Thus, the first device 701 can then display the digital content in the bottom-right of the slide instead of the bottom-left. The training data can also be based on more than one user, such as a test population viewing a draft of the slide deck. For example, the training data can be based on multiple presentations of the slide deck given to multiple audiences, wherein eye tracking software determines the average location of the audience's focus on each of the slides.

In an embodiment, the first device 701 employs other processes to associate the unique identifiers with the digital content. To this end, FIG. 3C is a flow chart of a sub-method of associating the unique identifiers with digital content, according to an embodiment of the present disclosure. In step 9820a, the first device 701 can send the unique identifiers to the networked device 750 and the networked device 750 can retrieve metadata that describes the digital content, the digital content being associated with the surface area through the unique identifiers. This can be done by querying a remote location, such as a database or a repository, using the unique identifiers of the surface area as the query key. In an embodiment, the first device 701 sends the unique identifiers to the networked device 750 and the networked device 750 associates the unique identifier of the reference patch to corresponding digital content based on the metadata. The metadata associated with the surface area's unique identifier can be transmitted to the first device 701 with the augmentation content.

In step 9820b, the first device 701 can assemble the digital content that is associated with the surface area's unique identifier. The assembly can entail loading the necessary assets for assembling the digital content. In an embodiment, this can entail loading manipulation software or drivers in order to enable the first device 701 to process the digital content. Other assembling processes can be the loading of rendering information in order to transform and manipulate an individual portion of the digital content. Furthermore, the loaded manipulation software, drivers, or rendering information can be used to compile all the individual portions of the entire digital content together. In an embodiment, this can include adapting the file formats of the digital content, delaying the playback for the digital content, converting from one format to another, scaling the resolution up or down, converting the color space, etc.

In step 9820c, the first device 701 can provide access control parameters for the digital content. The access control parameters can dictate whether the digital content is visible to some users, or to some geographical locations, or to some types of displays and not others, as well as the date and time or duration of time a user can access the digital content. In an embodiment, visibility of the digital content can be defined for an individual. For example, the digital content can be a video that is appropriate for users over a certain age. In an embodiment, visibility of the digital content can be defined for a geographic location. For example, the digital content can be a video that is region-locked based on a location of the first device 701. In an embodiment, visibility of the digital content can be defined for a type of display displaying the displayed data. For example, the digital content can be VR-based and will only display with a VR headset. In an embodiment, visibility of the digital content can be defined for a predetermined date and a predetermined time. For example, the digital content can be a video that will only be made publicly available after a predetermined date and a predetermined time. In an embodiment, visibility of the digital content can be defined for a time period. For example, the digital content can be a video that is only available for viewing during a holiday. The first device 701 thus calculates the user's access level based on those parameters and provides an output result as to the user's ability to access the digital content, i.e., whether the digital content will be visible or invisible to the user. Note that the access control parameters can be global, for all the displayed data, or it can be localized per surface area and the underlying digital content.

Referring again to FIG. 3A, in step 9825, the first device 701 can carry on the processes of overlaying the surface area with the digital content into the displayed data in accordance with the surface area, the position, and the size identified by the unique identifier. The first device 701 can determine or adjust the size and location of the assembled digital content on the surface area relative to the size and shape of the displayed data being outputted by the display. Then, the first device 701 can render the associated digital content (or the assembled individual portions) over the surface area's shape and perimeter using the size and location information. Thus, the digital content is superimposed on top of the surface area.

In one embodiment, a device (e.g., the first device 701) can inspect the memory of the device in order to identify the reference patch. A frame buffer stores a limited number of frames of displayed data. Displayed data can also be stored in the main memory of a device, wherein the main memory refers to internal memory of the device. The operating system (OS) and software applications can also be stored in the main memory of a device.

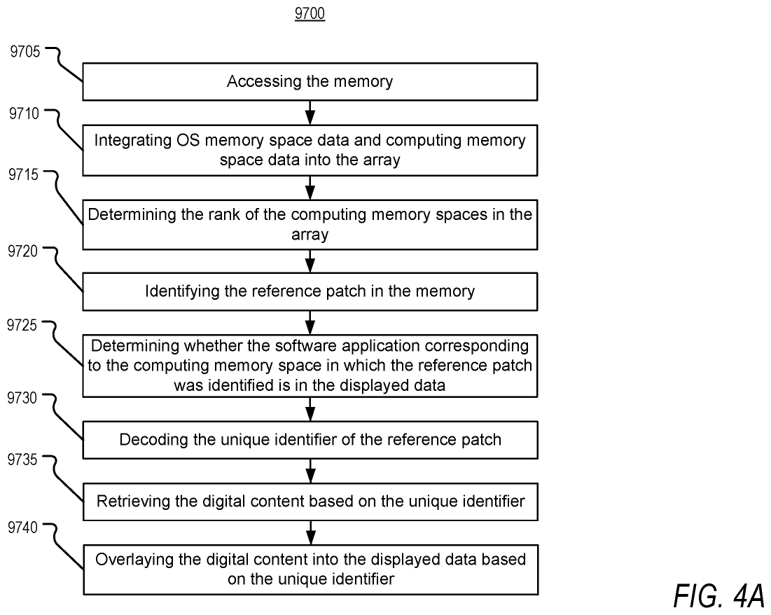

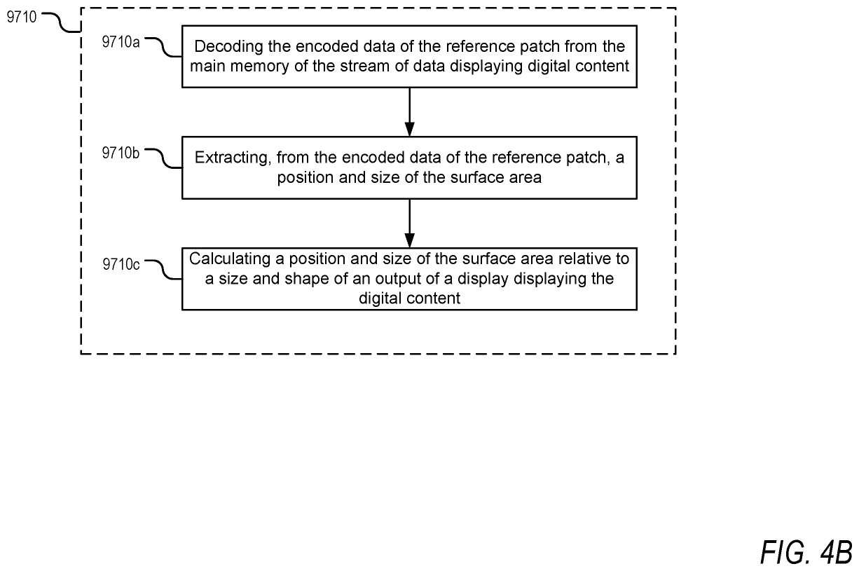

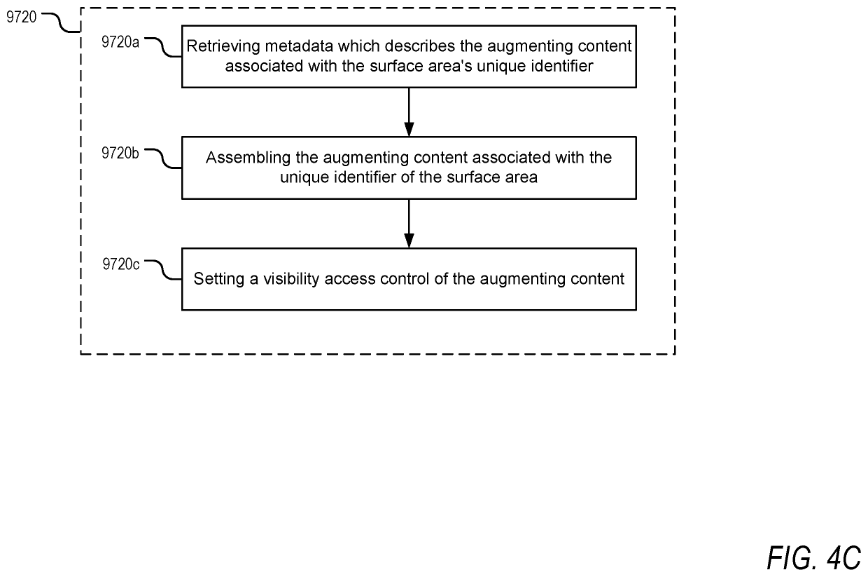

FIG. 4A is a flow chart for a method 9700 of identifying the reference patch included in the displayed data and overlaying the digital content into displayed data, according to an embodiment of the present disclosure. In an embodiment, in step 9705, the first device 701 can inspect the main memory on the first device 701. Again, the main memory of the first device 701 refers to physical internal memory of the first device 701 where all the software applications are loaded for execution. Sometimes complete software applications can be loaded into the main memory, while other times a certain portion or routine of the software application can be loaded into the main memory only when it is called by the software application. The first device 701 can access the main memory of the first device 701 including an operating system (OS) memory space, a computing memory space, and an application sub-memory space for the computing memory space in order to determine, for example, which software applications are running (computing memory space), how many windows are open for each software application (application sub-memory space), and which windows are visible and where they are located (or their movement) on the display of the first device 701 (OS memory space). That is to say, the OS memory takes up a space in (or portion of) the main memory, the computing memory takes up a space in (or portion of) the main memory, and the application sub-memory takes up a space in (or portion of) the computer memory. This information can be stored, for example, in the respective memory spaces. Other information related to each software application can be obtained and stored and is not limited to the aforementioned features.

In an embodiment, in step 9710, the first device 701 can aggregate the various memory spaces into an array (or table or handle). That is, the first device 701 can integrate data corresponding to the OS memory space and data corresponding to the computing memory space into the array. The array can be stored on the main memory of the first device 701 and include information regarding the software applications running on the first device 701. In an embodiment, the computing memory spaces (including the application sub-memory spaces) can be aggregated into the array. This can be achieved by querying the main memory for a list of computing memory spaces of all corresponding software applications governed by the OS and aggregating all the computing memory spaces obtained from the query into the array. This can be, for example, aggregating the computing memory space of a PowerPoint file and the computing memory space of a Word file into the array. The information in the computing memory spaces stored in the array can include metadata of the corresponding software application. For example, for PowerPoint, the information in the array can include a number of slides in a presentation, notes for each slide, etc. Moreover, each window within the PowerPoint file and/or the Word file can be allocated to a sub-memory space. For example, the array can include the location of each window for each software application running on the first device 701, which can be expressed as an x- and y-value pixel coordinate of a center of the window. For example, the array can include the size of each window for each software application running on the first device 701, which can be expressed as a height and a width value.

In an embodiment, in step 9715, the first device 701 can determine a rank or a hierarchy of the computing memory spaces in the array. The rank can describe whether a window of a software application or the software application itself is active or more active as compared to another software application running on the first device 701. An active window or software application can correspond to the window or software application that is currently selected or clicked in or maximized. For example, an active window can be a window of a web browser that the user is scrolling through. In an embodiment, this can be achieved by querying the OS memory space and each computing memory space in the main memory for existing sub-memory spaces, querying the OS memory space and each computing memory space in the main memory for a rank or hierarchical relationship between (software application) sub-memory spaces found, recording the list of sub-memory spaces and the rank relationship between sub-memory spaces, and associating the list of sub-memory spaces and the rank relationship between the sub-memory spaces with the array. For example, a window of a first application can be an active window on the first device 701 and has a higher rank than an inactive window of a second application also running on the first device 701. The active window can be the window the user has currently selected and displayed over all other windows on the display of the first device 701. Notably, there can be multiple visible windows, but one of said multiple visible windows can have a higher rank because it is currently selected by the user and the active window.

For example, two documents can be viewed in a split-screen side-by-side arrangement without any overlap of one window over another window, and a third document can be covered by the two documents in the split-screen side-by-side arrangement. In such an example, the user can have one of the two split-screen documents selected, wherein the selected document is the active window and would have a higher rank (the highest rank) than the other of the two split-screen documents since the higher (highest) ranked document is selected by the user. The third document behind the two split-screen documents would have a lower rank (the lowest rank) than both of the two split-screen documents since it is not visible to the user. Upon bringing the third document to the front of the display and on top of the two split-screen documents, the third document rank would then become the highest rank, while the two split screen documents' rank would become lower (the lowest) than the third document (and the rank of the two split screen documents can be equal).

In an embodiment, the rank can be determined based on eye or gaze tracking of the user (consistent with or independent of whether a window is selected or has an active cursor). For example, a first window and a second window can be visible on the display, wherein the first window can include a video streaming from a streaming service and the second window can be a word processing document. The rank of the first window and the second window can be based on, for example, a gaze time that tracks how long the user's eyes have looked at one of the two windows over a predetermined time frame. The user may have the word processing document selected and active while the user scrolls through the document, but the user may actually be watching the video instead. In such a scenario, an accrued gaze time of the first window having the video can be, for example, 13 seconds out of a 15 second predetermined time frame, with the other 2 seconds in the predetermined time frame being attributed to looking at the first window having the word processing document. Thus, the rank of the first window having the video can be higher than the rank of the second window because the gaze time of the first window is higher than the gaze time of the second window. Notably, if there is only one open window, the rank of that window would be ranked as the top-ranked window (because it is the only window) regardless of/independent from other user input, such as gaze, selection, etc.

In an embodiment, the rank can be determined based on the eye tracking and a selection by the user. For example, the user can select the first window having the video and looking at a description of the video playing in the same first window. In such a scenario, both the eye tracking accruing a longer gaze time (than the second window) and the user selecting the first window to make it the active window can make the first window the top-ranked window.

Thus, the rank can be determined based on one or more elements. The more elements being used, the more accurate the determination of the rank. Hence, the rank can be determined by a combination of eye or gaze tracking, an input selection by a user (for example, the user clicking on an icon or a display element in a window (the first window or the second window), a user hovering a mouse or pointer over a portion of a window (without necessarily clicking or selecting anything), etc. The rank determination can also go beyond these elements/factors to include preset settings related to a particular user and/or past behavior/experiences. For example, the user can preset certain settings and/or the user's device can learn from user's past behavior/experiences about his/her preference when two or more windows are displayed at the same time side by side.

For example, this particular user may always play a video in the first window while working on a presentation in the second window. In such case, the user's device can learn from this behavior and use this knowledge to more accurately determine the rank (for example, when the first window has a video playing and the second window corresponds to a work processing document or a presentation, the active window is likely the second window). Such knowledge can be paired with eye gaze direction and other factors such as mouse/cursor movement, etc. in order to more accurately determine the rank.

In an embodiment, in step 9720, the inspected main memory data can also include a reference patch therein and the first device 701 can identify the reference patch in the main memory data. In an embodiment, the first device 701 can detect and identify the reference patch in the main memory by a value, such as a known encoding, where the format of the of the data itself can indicate to the application where the reference patch is located. For example, the known encoding can be 25 bytes long and in a predetermined position within the binary bits of the main memory. In one embodiment, the first device 701 inspects the main memory data for bit data corresponding to the reference patch. For example, the bit data corresponding to the reference patch is an array of bits corresponding to pixel data making up a reference patch. In one embodiment, the presence of the reference patch is an attribute of an object or a class. In one embodiment, the reference patch is a file used by an application wherein the file is loaded into the main memory when the reference patch is displayed by the application. In one embodiment, the presence of the reference patch is indicated in metadata, e.g., with a flag. In an embodiment, the reference patch can be identified by parsing an application (e.g. a Word document), looking through the corresponding metadata in the computing memory space, and finding the reference patch in the metadata by attempting to match the metadata with a predetermined indicator indicating the presence of the reference patch, such as the unique identifier.

In step 9725, the first device 701 can determine whether the software application corresponding to the computing memory space (and sub-memory space) in which the reference patch was identified is active or in the displayed data. Referring to the example of step 9715, while the window of the first application can include the reference patch, the inactive window of the second application can become active and overlay over the window of the first application which was previously the active window. In such a scenario, the reference patch in the window of the first application can become covered by the window of the second application. As such, the digital content of the reference patch in the window of the first application need not be displayed or can cease being displayed. However, in an alternative scenario, the window of the first application, including the reference patch, can be active and the reference patch therein can be uncovered and visible. In one embodiment, the active window refers to the window with the most recent interaction, e.g., a click, a movement. In one embodiment, the first device 701 uses a priority list to determine which window is the active window. For example, digital content for a first application with higher priority than a second application will be displayed even if the second application covers the reference patch of the first application.

In step 9730, upon determining the software application corresponding to the computing memory space (and sub-memory space) in which the reference patch was identified is active or in the displayed data, the first device 701 can decode the encoded data of the unique identifiers from the area of the reference patch, wherein the unique identifiers correspond to the surface area.

In step 9735, the first device 701 can use the unique identifiers to link the surface area with the digital content using metadata and retrieve the digital content based on the unique identifiers.

In step 9740, the first device 701 can overlay the digital content onto the surface area of the displayed data based on the unique identifiers.

Again, the method of identifying the reference patch included in the displayed data and augmenting the displayed data is described as performed by the first device 701, however, the networked device 750, the second client/user device 702, and/or the nth device 70n can alternatively or additionally perform the same functions.

In an embodiment, the first device 701 identifies the surface area corresponding to the reference patch by employing further processes. To this end, FIG. 4B is a flow chart of a sub-method of identifying the reference patch with the unique identifiers corresponding to the surface area from the stream of data, according to an embodiment of the present disclosure.

In step 9710a, the first device 701 can decode the encoded reference patch from the main memory. The encoded reference patch can include the marker that makes up the unique identifiers within the reference patch incorporated previously. The reference patch can also include other identifying information. The marker can be disposed within the reference patch, such as within the area of the reference patch or along a perimeter of the reference patch, or alternatively, outside of the area of the reference patch.

Again, whatever schema is used to encode the marker in the reference patch is also used in reverse operation to decode the underlying information contained within the reference patch. As stated above, in an embodiment, the encoded marker can be patterns generated and decoded using the ArUco algorithm or by other algorithms that encode data according to a predetermined approach.

Similarly, as described above, in step 9710b, the first device 701 can also extract attributes of the surface area from the reference patch.

Similarly, as described above, in step 9710c, the first device 701 can also calculate a position and size of the surface area relative to the size and shape (dimensions) of the output signal from the display that is displaying the displayed data.

Similarly, as described above, the first device 701 can provide information regarding the characteristics of the output video signal, such that the digital content that is later overlaid can correctly be displayed to account for various manipulations or transformations that may take place due to hardware constraints, user interaction, image degradation, or application intervention. Such manipulations and transformations may be the relocation, resizing, and scaling of the reference patch and/or the surface area, although the manipulations and transformations are not limited to those enumerated herein.

Similarly, as described above, the reference patch itself can be used as the reference for which the digital content is displayed on the surface area.

Similarly, as described above, the first device 701 can determine an alternative location at which to display the digital content based on behaviors of the user.

In an embodiment, the first device 701 employs other processes to associate the unique identifiers with the digital content. To this end, FIG. 4C is a flow chart of a sub-method of associating the unique identifiers with digital content, according to an embodiment of the present disclosure. In step 9720a, the first device 701 can send the unique identifiers to a second device. The second device can be, for example, a networked device 750. The second device can retrieve metadata that describes the digital content, the digital content being associated with the surface area through the unique identifiers. This can be done by querying a remote location, such as a database or a repository, using the unique identifiers of the surface area as the query key. In an embodiment, the first device 701 sends the unique identifiers to the second device and the second device associates the unique identifier of the reference patch to corresponding digital content based on the metadata. The metadata associated with the surface area's unique identifier can be transmitted to the first device 701 with the augmentation content.

In step 9720b, the first device 701 can assemble the digital content that is associated with the surface area's unique identifier. The assembly can entail loading the necessary assets for assembling the digital content. In an embodiment, this can entail loading manipulation software or drivers in order to enable the first device 701 to process the digital content. Other assembling processes can be the loading of rendering information in order to transform and manipulate an individual portion of the digital content. Furthermore, the loaded manipulation software, drivers, or rendering information can be used to compile all the individual portions of the entire digital content together. In an embodiment, this can include adapting the file formats of the digital content, delaying the playback for the digital content, converting from one format to another, scaling the resolution up or down, converting the color space, etc.

In step 9720c, the first device 701 can provide access control parameters for the digital content. The access control parameters can dictate whether the digital content is visible to some users, or to some geographical locations, or to some types of displays and not others, as well as the date and time or duration of time a user can access the digital content or is allowed to access. In an embodiment, visibility of the digital content can be defined for an individual. For example, the digital content can be a video that is appropriate for users over a certain age. In an embodiment, visibility of the digital content can be defined for a geographic location. For example, the digital content can be a video that is region-locked based on a location of the first device 701. In an embodiment, visibility of the digital content can be defined for a type of display displaying the displayed data. For example, the digital content can be VR-based and will only display with a VR headset. In an embodiment, visibility of the digital content can be defined for a predetermined date and a predetermined time. For example, the digital content can be a video that will only be made publicly available after a predetermined date and a predetermined time. In an embodiment, visibility of the digital content can be defined for a time period. For example, the digital content can be a video that is only available for viewing during a holiday. The first device 701 thus calculates the user's access level based on those parameters and provides an output result as to the user's ability to access the digital content, i.e., whether the digital content will be visible or invisible to the user. Note that the access control parameters can be global, for all the displayed data, or it can be localized per surface area and the underlying digital content.

Referring again to FIG. 4A, in step 9740, the first device 701 can carry on the processes of overlaying the surface area with the digital content into the displayed data in accordance with the surface area, the position, and the size identified by the unique identifier. The first device 701 can determine or adjust the size and location of the assembled digital content on the surface area relative to the size and shape of the displayed data being outputted by the display. Then, the first device 701 can render the associated digital content (or the assembled individual portions) over the surface area's shape and perimeter using the size and location information. Thus, the digital content is superimposed on top of the surface area.

The first device 701 can continuously monitor changes that are taking place at the end user's device (such as the networked device 750 of the second user) to determine whether the reference patch and/or the surface area has moved or been transformed in any way (see below for additional description). Thus, the first device 701 can continuously inspect subsequent frames of the stream of the data (for example, every 1 ms or by reviewing every new frame), displaying the displayed data, to determine these changes. The first device 701 can further continuously decode the reference patch's data from the identified reference patch. Then the first device 701 can continuously extract attributes from the data, the attributes being of size, shape, and perimeter and comparing those changes between the current frame and last frame. Further, the first device 701 can continuously calculate the size and location of the surface area and compare changes between the size and location of the surface area from the current and the last frame and then continuously overlay the digital content on the surface area by incorporating the changes in the reference patch's attributes and the changes in the size and location of the surface area. As stated above, when the user manipulates his/her display device by scaling, rotating, resizing or even shifting the views from one display device and onto another display device, the first device 701 can track these changes and ensure that the digital content is properly being superimposed onto the surface area.

In an embodiment, the methodologies discussed with reference to FIG. 3 that use the frame buffer can be used without using the methodologies discussed with reference to FIG. 4 that use the memory space and vice-versa. In other words, in an embodiment, either the methodologies of FIG. 3 or the methodologies of FIG. 4 can be used to identifying a reference patch and overlay the digital content in displayed data.

However, in an embodiment, both the methodologies discussed with reference to FIG. 3 that use the frame buffer and the methodologies discussed with reference to FIG. 4 that use the memory space can be used together. In such embodiment, a device can use both approaches to accurately identify the same reference patch (applying both approaches can yield better results). In an embodiment, both approaches can be used to identify different reference patches. For example, if a document includes reference patches, the first device can apply the methodologies discussed with reference to FIG. 3 to a first reference patch, while applying the methodologies discussed with reference to FIG. 4 to a second reference patch.

An illustrative example will now be discussed: a scenario where a user (for example, a user at the first device 701) receives (from another device such as the second client/user device 702) an email with the embedded reference patch in the body of the email or as an attached document. The reference patch within the displayed data (email) can show a facade of the digital content or the reference patch. The application on the first device 701 can scan the display to find the reference patch and the surface area and the attributes within the displayed data as it is being displayed. Furthermore, the first device 701 can access the digital content using the unique identifier and metadata and prepare it for overlaying. At which point, the user (i.e., the recipient) can select the digital content by various ways such as by clicking on the digital content's facade or the surface area, or otherwise indicating that it intends to access the digital content.

Thereafter, the digital content can be retrieved from the networked device 750 using the unique identifier and the metadata saved within a database that directs the networked device 750 to where the digital content is saved and can be obtained. That is, the networked device 750 can determine the digital content corresponding to the derived unique identifier and send the digital content corresponding to the unique identifier (and the metadata) to the first device 701. Then, the first device 701 can superimpose (overlay) the digital content on the surface area. While the digital content is being received and overlayed on the surface area, the first device 701 can continually monitor the location, size and/or shape of the reference patch and/or the surface area to determine movement and transformation of the reference patch and/or the surface area. If the user has moved the location of the reference patch and/or the surface area, or has resized or manipulated the screen for whatever purpose, the new location, shape and/or size information of the reference patch and/or the surface area is determined in order to display the digital content properly within the bounds of the surface area. Thus, the digital content moves with the displayed data as the displayed data is moved or resized or manipulated.

In an embodiment, a user that has received the displayed data embedded with the reference patch can access the digital content on his/her first device 701, as described above. The user may want to transfer the ongoing augmenting experience from the first device 701 to another device, such as the device 70n, in a seamless fashion. In that scenario, the user is able to continue the augmenting experience on his/her smartphone, smartwatch, laptop computer, display connected with a webcam, and/or tablet pc. The user therefore can capture the embedded reference patch and therefore the encoded attributes, as the digital content is being accessed and overlaid unto the surface area. The user can capture the embedded reference patch by taking a picture of it or acquiring the visual information using a camera of the second client/user device 702 as mentioned above. The user can capture the embedded reference patch by accessing the main memory of the second client/user device 702 as mentioned above.

Assuming the user also has the functionality included or the application installed or running on the device 70n, the device 70n would recognize that an embedded reference patch and encoded unique identifiers are in the captured image/video stream or in the main memory of the device 70n, such as in the corresponding computing memory space as the software application currently active on the device 70n. Once the surface area has been determined and the reference patch decoded, the digital content can be obtained from the networked device 750, using the unique identifiers and the metadata and then overlaid on the surface area within the displayed data displayed on the device 70n. In an embodiment, as soon as the device 70n superimposes the digital content onto the surface area, the networked device 750 or the backend determines that the stream has now been redirected onto the device 70n and thus pushes a signal to the first device 701 to stop playing the digital content on the first device 701. The device 70n that is overlaying the digital content therefore resumes the overlaying at the very same point that the first device 701 stopped overlaying the digital content (for instance, when the content is a video). Thus, the user is able to handoff the digital content from one device to another without noticing delay or disruption in the augmenting experience.

In one embodiment, the visibility of the digital content is dynamic and can be adjusted. For example, in one context an augmentation overlaps with another image and obscures the image by being displayed in front of the image. At a later time, the augmentation is displayed behind the image such that the image obscures the augmentation when the augmentation is no longer needed. In one embodiment, the transparency of an augmentation can be adjusted to show objects in the same location as the augmentation. In one embodiment, the interactive properties of digital content are also dynamic and can be modified. Click-ability refers to whether an object can be clicked or otherwise activated by a trigger, thus causing an action to be performed. The action includes, but is not limited to, sending data, receiving data, and/or modifying display content. When the click-ability of an object is on, the trigger causes the action to be performed. When click-ability of an object is off, the trigger does not cause the action to be performed. Touch-ability is a subset of click-ability wherein the trigger is a touch using a touch panel. The trigger can be collected by an input device, including, but not limited to, a mouse, a keyboard, a touch panel, a camera, and/or a microphone.

The click-ability of any augmentation layer and/or object of digital content can be modified. In one embodiment, the click-ability of an object in a layer can be modified independently of other objects in that layer. For example, only one button is active (clickable) while other buttons in the augmentation are not active. In addition, objects in different layers can simultaneously be clickable. For example, the original displayed data is a slide deck wherein a slide in the slide deck includes a button for proceeding to a next slide. The slide includes a reference patch, and an electronic device identifies the reference patch and displays an augmentation including a multiple-choice survey. The answers to the multiple-choice survey and the button for proceeding to the next slide are all clickable, enabling a user to interact with the augmentation as well as the original displayed data. In another embodiment, the button for proceeding to the next slide is not clickable until an answer to the multiple-choice survey has been collected. Thus, inputs and interactions on one layer can be used to affect another layer. In one embodiment, transparency and click-ability can be adjusted at a pixel level. For example, if an object is partially obscured, only the visible part of the object is clickable.

In one embodiment, click-ability and transparency can be connected. For example, a first clickable object in a first layer and a second clickable object in a second layer are located on the same surface area of a display. The click-ability of the first clickable object is on and the click-ability of the second clickable object is off for a period of time. During this period of time, the second clickable object is transparent and only the first clickable object is visible on the display.

After the period of time elapses, the click-ability of the first clickable object is turned off, while the click-ability of the second clickable object is turned on. Accordingly, the first clickable object is then transparent while the second clickable object is not transparent. The transparency and click-ability of the objects can be set independently of the order in which layers are created, edited, retrieved, and/or displayed. In another example, an electronic device displays a full-screen Microsoft PowerPoint® presentation and full-screen scrolling speaker's notes at the same time in one window, wherein the click-ability of any of the pixels of the presentation and the notes can be adjusted to be on or off. The result is a multi-layered content stack experience wherein attributes such as transparency and click-ability for any layer in the stack can be adjusted at the pixel level.

In one embodiment, pixels in one layer can have click-ability on, while pixels in the remaining layers can have click-ability off. Further, portions of pixels within layers that have click-ability off can have their click-ability turned on, while the remaining pixels in that layer remain off (and vice versa). The determination of which pixels have click-ability on and off can be determined based on parameters including, but not limited to, user settings, hot spots, application settings, user input. Hot spots can refer to regions of a computer program, executed by circuitry of a device, where a high percentage of the computer program's instructions occur and/or where the computer program spends a lot of time executing its instructions. Examples of hot spots can include play/pause buttons on movies, charts on presentations, specific text in documents, et cetera.

Referring back to the displayed data discussed above, in an example, the displayed data can be a page of a website. The webpage may be dedicated to discussions of strategy in fantasy football, a popular online sports game where users manage their own rosters of football players and points are awarded to each team based on individual performances from each football player on the team. After reading the discussion on the website page, the reader may wish to update his/her roster of football players. Traditionally, the reader would be required to open a new window and/or a new tab and then navigate to his/her respective fantasy football platform, to his/her team, and only then may the reader be able to modify his/her team. Such a digital user experience is cumbersome and inefficient. With augmentation, however, the reader may not need to leave the original webpage as a reference patch corresponding to a fantasy football augmentation may be positioned within the viewable area of the website page. The corresponding augmentation may be, for instance, an interactive window provided by a third-party fantasy football platform that allows the reader to modify his/her roster without leaving the original website. Thus, instead of navigating to a different website and losing view of the informative fantasy football discussion, the reader can simply interact with the digital object of the augmentation in the current frame of displayed data because of the presence of the reference patch.

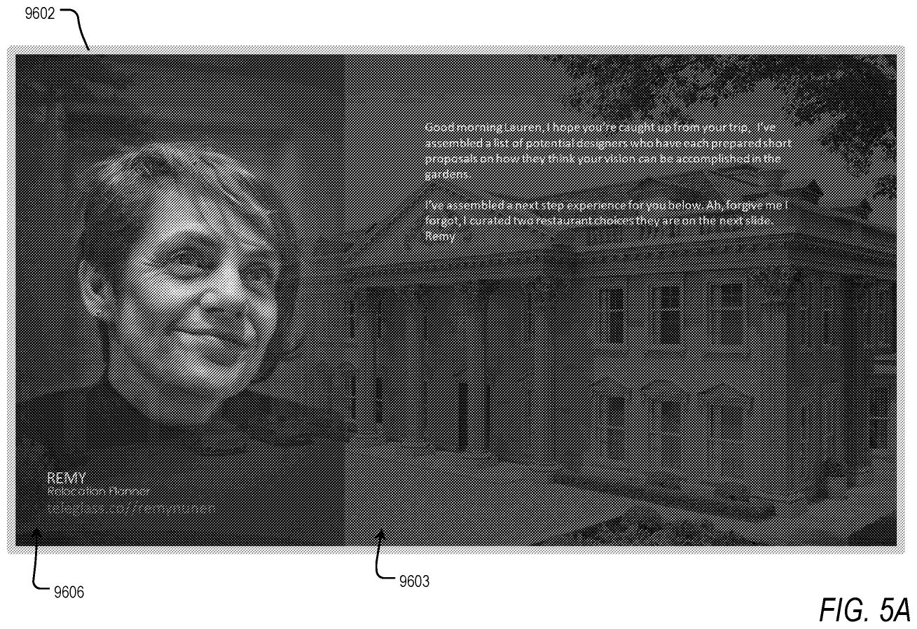

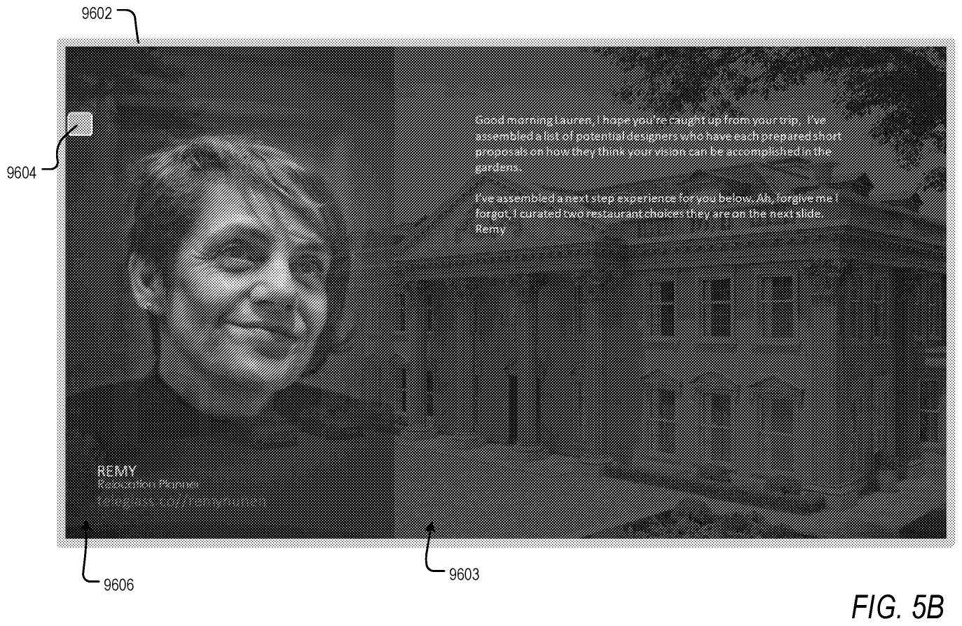

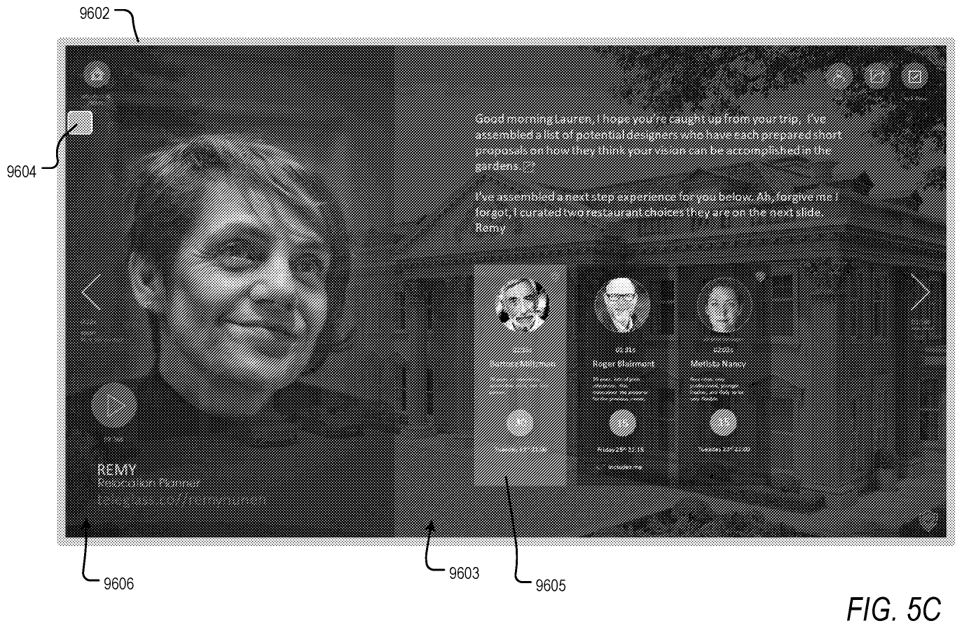

In another example, as will be described with reference to FIG. 5A through FIG. 5C, the displayed data can be a slide deck. The slide deck may be generated by a concierge-type service that seeks to connect a client with potential garden designers. As in FIG. 5A, the slide deck may be presented to the client within a viewable area 9603 of a display 9602. The presently viewable content of the slide deck within the viewable area 9603 of the display 9602 may be a current frame 9606 of displayed data. Traditionally, the slide deck may include information regarding each potential garden designer and may direct the client to third-party software applications that allow the client to contact each designer. In other words, in order to connect with one or more of the potential garden designers, the client, traditionally, may need to exit the presentation and navigate to a separate internet web browser in order to learn more about the garden designers and connect with them. Such a digital user experience is cumbersome and inefficient. With augmentation, however, the client need not leave the presentation in order to set up connections with the garden designers. For instance, as shown in FIG. 5B, a reference patch 9604 can be positioned within the slide deck so as to be in the current frame 9606 and viewable within the viewable area 9603 of the display 9602 at an appropriate moment. As shown in FIG. 5C, the reference patch 9604 may correspond to one or more augmentations 9605 and, when the reference patch 9604 is visible, the augmentations 9605 are displayed and brought to life. The one or more augmentations 9605 can include, as shown in FIG. 5C, interactive buttons, images, videos, windows, and icons, among others, that allow the client to interact with the secondary digital content and to, for instance, engage with the garden designers without leaving the presentation. In an example, the interactive augmentations 9605 may allow for scheduling an appointment with a given garden designer while still within the slide deck. In one embodiment, the augmentations are only presented when the reference patch is included in the displayed data. In one embodiment, the reference patch identifies the digital content of the augmentation. The digital content of the augmentations is visually integrated into the displayed data.

The above-described augmentations are particularly relevant to environments where the underlying content is static. Static content may include textual documents or slide decks. Often, the static content is stored locally. A result of the static content is static augmentations that are not capable of dynamically adjusting to or being adjusted dynamically according to complex user interactions, in real-time, during a user experience. The addition of dynamic augmentations improves user experience by providing additional data and personalized, interactive elements.

Such a dynamic environment includes one where, for instance, a video conversation is occurring. A first participant of the video conversation may share his/her screen with a second participant of the video conversation and wish to remotely control an augmentation on a display of a device of the second participant. By including a reference patch within the displayed data that is being ‘shared’, which may be the video itself or another digital item, where sharing the displayed data includes transmitting the displayed data over a communication network from the first participant to the second participant, the second participant may be able to experience the augmentation when the device of the second participant receives the transmitted displayed data and processes it for display to the user.

Generally, and as introduced in the above example of a dynamic environment, a reference patch can be inserted into displayed data displayed on a first computer. The display of the first computer can be streamed to a second computer. In an example, the second computer decodes the streamed display and identifies the reference patch in the displayed data. Based on the identified presence of the reference patch, the second computer can locally augment the display of the second computer to overlay the intended augmentation on the ‘streamed’ display from the first computer. The design and the arrangement of the augmentation can be provided relative to the reference patch placed into the displayed data on the first computer. The augmentation can include a number of objects to be displayed and may be configured to display different subsets of objects based on interactions of a user with the augmentation. The objects, therefore, can be interactive. In one embodiment, the second computer can retrieve the augmentation from a server. Thus, the augmentation is not included directly in the displayed data streamed from the first computer to the second computer but is retrieved and included in the display at a later time. In one embodiment, the unique identifier included in the reference patch provides further information and/or instructions for retrieving the augmentation.

In one embodiment, an electronic device such as the first device 701 can render and display image data with adjustable regional transparency and click-ability. The image data can include the displayed data and/or the digital content. In one embodiment, the displayed data and/or digital content can include a video represented by video data, wherein the video data can include an alpha channel for storing transparency data for each pixel. The video data can be transmitted in or converted to a format that supports the alpha channel. The video can be displayed, e.g., by a video player, wherein the transparency of each pixel in the video can be adjusted according to a desired composite image. The composite image can include all visible data (e.g., image data) displayed by the first device 701. The composite image can be a combination of image data from various applications, programs, sources, and/or windows displayed by the first device 701. For example, the composite image can include a slide deck with a video of a presenter overlayed on the slide deck. The slide deck can be displayed by a presentation software, while the video can be displayed by a video player program. As another non-limiting example, the composite image can include a text document with an image file overlayed on the text document. In one embodiment, the regional transparency of any image or window in the composite image can be adjusted by the first device 701. When a first image or window in the composite image is transparent, a second image or window present behind the transparent region can be visible through the transparent region. In one embodiment, the first device 701 can create the composite image after inspecting the main memory to determine visible image data from each window, application, and/or image stored in the main memory. The first device 701 can then load the composite image into the frame buffer for display.

In one embodiment, the transparency of each pixel can be adjusted, for example, along a gradient between completely transparent and completely opaque. For example, an alpha channel value of 128 in an 8-bit system for a pixel can correspond to the pixel being displayed with a transparency approximately halfway between fully transparent and fully opaque. The resulting pixel will include a combination of image data from multiple sources. In one embodiment, the combination can be a weighted average of image data at that pixel location from multiple sources, wherein the weights correspond to the transparency of each pixel at that pixel location. The bit depth of the alpha channel and the individual pixel adjustment can enable regional transparency of the image data according to the present disclosure. For example, certain regions of a video can be made transparent, while other regions are opaque. The video can then be overlayed onto displayed data and/or digital content for a seamless visual experience, wherein the video and the displayed data and/or digital content appear visually integrated into a single layer in the composite image.

In typical video players, the display of a video is confined to data loaded into the video player. If a portion of the video is transparent, only a background image stored or set in the video player (e.g., a default background or a blank screen) will be visible through the transparent portion.

The transparency of the video does not provide functional or visual benefit because the video is not integrated into image data that is external to the video player. In one embodiment, the video can be played by a video player on an electronic device (e.g., the first device 701) wherein image data that is external to the video player can be visible through transparent portions of the video. The video player can thus achieve full transparency of the video that is being played. For example, the video can be overlayed on top of displayed data such that both the video and the displayed data appear as if they are displayed in the same window. As another example, a video is being played by a first application, e.g., a video player. A second application, e.g., a word processing software, is open on the same device, wherein the second application displays a text document. The video player is displayed in front of the word processing software. The text document is visible through transparent regions of the video being played by the video player. The video is fully integrated into all of the displayed data rather than being confined to the video player. Thus, the video can be used to highlight areas of the text document in a dynamic manner. The same effect can be applied if the first application displays a static image given that video data is made up of static frames.

In another example embodiment, the image data can include a first video feed and a second video feed. The two video feeds can be overlayed with regional transparency, wherein transparency in the second video feed results in the first video feed being visible in place of the transparent region of the second video feed. The overlayed data can include different file formats and/or different applications.

In one embodiment, the integration of the transparent video with the displayed data and/or the digital content can be accomplished by inspecting main memory, as described above. An electronic device such as the first device 701 can inspect the main memory of the first device 701 to identify what is being displayed by each application, program, or window open on the first device 701. The first device 701 can then determine which pixels in the displayed data and/or the digital content are transparent as defined in the alpha channel. The first device 701 can merge or replace transparent pixels displayed by a first application with non-transparent pixels from applications or windows that occupy the same location on the display as the transparent pixels. The non-transparent pixels from the applications or windows can then be visible in place of the transparent pixels.

In one embodiment, the first device 701 can aggregate memory spaces from the main memory into an array. The array can include information regarding software applications running on the first device 701. The array can include image data meant for display by each of the applications, as well as the location parameters of the image data, wherein the location parameters can be expressed as a pixel coordinate (e.g., a center pixel) and a size (e.g., a window height and a window width). The first device 701 can inspect the memory spaces in the array to determine the visibility of each pixel for each application in order to create the composite image. For example, in a typical display, if there is an overlap between a top application and a bottom application without transparency, the first device 701 can use the data in the array to display a top application in the region of the overlap instead of a bottom application. In one embodiment, if the region of overlap in the top application is transparent, the first device 701 can display the bottom application in the transparent region of the top application instead of the top application. In one embodiment, the image data can be translucent or partially transparent rather than fully transparent. The first device 701 can combine partially transparent image data with underlying image data so that both are visible, with the partially transparent image data partially obscuring the underlying image data.

In one embodiment, the first device 701 can inspect the frame buffer and use computer vision (as described above) to identify a transparent region in a frame of image data. The first device 701 can identify a location, a shape, and/or a size of the transparent region using computer vision. The first device 701 can then determine what to display in place of the transparent region. In one embodiment, the first device 701 can access the main memory to determine image data from windows, applications, or programs in the same location as the transparent region in order to create the composite image. In another embodiment, the first device 701 can load image data into the frame buffer and inspect the frame buffer to determine the image data in the same location as the transparent region. In one embodiment, the image data that is visible through the transparent region can be image data from the OS of the device.

In one embodiment, the transparency of each frame of the image data can be adjusted by the first device 701 over time, e.g., in real time or near real time. For example, the first device 701 can display a dynamic image or a video, such as a live broadcast, and the transparency of additional data overlayed on the live broadcast can be adjusted based on what is being displayed on the live broadcast. In another non-limiting example, the first device 701 can display a slideshow, and the transparency of the additional data be adjusted based on the content of each slide in the slideshow. In one embodiment, the additional data can be digital content retrieved based on a reference patch. In another embodiment, the additional data can be displayed data stored in the memory of the first device 701.

In one embodiment, the first device 701 can be configured to detect objects and/or features in the image data and adjust the transparency of the image data accordingly. In one embodiment, the first device 701 can use computer vision to inspect the frame buffer in order to identify objects in the image data as described herein with reference to FIG. 3A through FIG. 3C. In one embodiment, the first device 701 can inspect the main memory of the first device 701 (as described above) to identify the objects in the image data. In one embodiment, the first device 701 can identify overlap between objects in the image data and automatically adjust the transparency of the objects accordingly. For example, the first device 701 can display digital content overlayed on displayed data such that any background regions in the digital content, or regions without objects, are transparent, and the displayed data is visible in place of the transparent regions.

In one embodiment, the first device 701 can adjust the transparency of the image data based on a prioritization of objects. It can be desired that certain objects are always visible. For example, a reference patch in displayed data needs to be visible in order for the first device 701 to incorporate corresponding digital content. A first device 701 can adjust the transparency of the digital content such that any region of the digital content that overlaps with the reference patch is transparent. In another example, an object in digital content, such as an interactive button, should always be visible when the digital content is visible. The first device 701 can adjust the transparency of the digital content such that the region where the interactive button is located is always opaque, even if the location of the button changes. In one embodiment, information about the visibility of the objects can be stored in the memory of the first device 701. In another embodiment, information about visibility of the objects can be transmitted to the first device 701, e.g., from a networked device 750. In yet another embodiment, the first device 701 can determine the visibility of the objects automatically based on object recognition as described herein.

In one embodiment, the first device 701 can use metadata to determine the transparency of the image data. For example, the first device 701 can receive a description of the image data. The description of the image data can be stored in memory. The description can include information about where objects in the image data are located, e.g., pixel coordinates, relative locations. In one embodiment, the image data can be dynamic, e.g., a video, and the description can further include timestamped information about the locations of the objects in the image data. The first device 701 can then adjust the transparency of the image data over time based on the description. For example, the first device 701 can display a video of a moving object. Digital content can be used to highlight the moving object when it is in a certain region. The digital content is transparent when the moving object is not in the region and visible when the moving object is in the region. The transparency of the digital content can be adjusted based on the location of the moving object, which can be included in the description of the video.

In one embodiment, the first device 701 can receive the image data, e.g., digital content, from a networked device 750, such as a server. The networked device 750 can determine the transparency of the digital content. In one embodiment, the networked device 750 can adjust the transparency of the digital content based on information received from the first device 701. For example, data encoded in the reference patch such as the unique identifiers and corresponding metadata can indicate transparency of regions of the digital content. As another non-limiting example, the networked device 750 can receive information from the first device 701 about the displayed data and use the information about the displayed data to adjust the transparency of the digital content. In another embodiment, the networked device 750 can identify objects in the digital content and/or the displayed data and adjust the transparency of regions in the digital content based on the identified objects. Thus, the alpha channel of the digital content can be modified by the networked device 750 and does not have to be modified by the first device 701. In one embodiment, the networked device 750 can adjust the transparency of the digital content in real time or near real time.

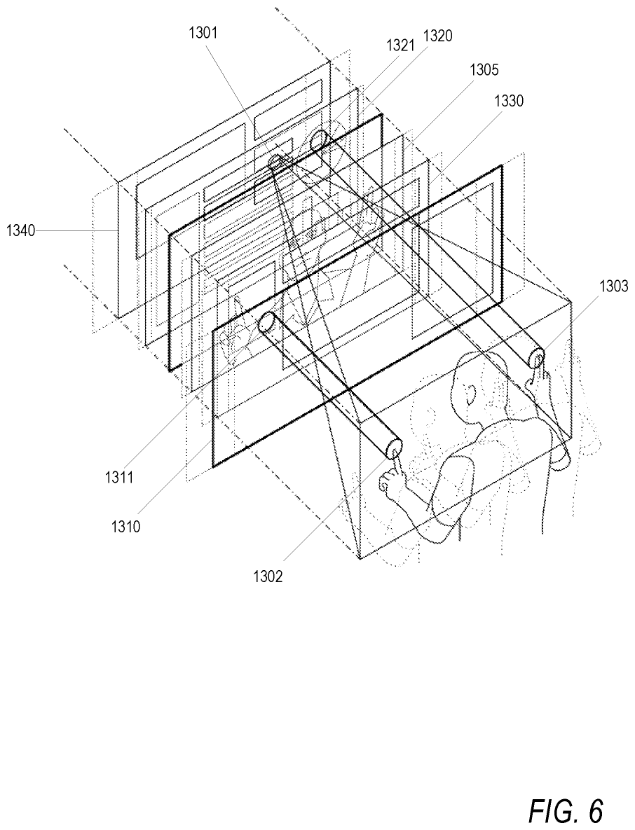

As shown in FIG. 6, in some embodiments, one or more of the disclosed functions and capabilities may be used to enable a volumetric composite of content-activated layers of transparent computing, content-agnostic layers of transparent computing and/or camera-captured layers of transparent computing placed visibly behind 2-dimensional or 3-dimensional content displayed on screens, placed in front of 2-dimensional or 3-dimensional content displayed on screens, placed inside of 3-dimensional content displayed on screens and/or placed virtually outside of the display of screens. Users can interact via touchless computing with any layer in a volumetric composite of layers of transparent computing wherein a user's gaze, gestures, movements, position, orientation, or other characteristics observed by a camera are used as the basis for selecting and interacting with objects in any layer in the volumetric composite of layers of transparent computing to execute processes on computing devices.

In one embodiment, a camera 1301 can be used to capture image or video data of a user interacting with the volumetric composite. The camera 1301 can be integrated into or connected to a device displaying the layers of the volumetric composite. In one embodiment, the volumetric composite can include a camera-captured layer 1305, wherein the camera-captured layer 1305 can include the image or video data of the user captured by the camera 1301. In the illustrative example of FIG. 6, the camera-captured layer 1305 can be placed visibly behind a first layer 1310 and in front of a second layer 1320. The first layer 1310 can be a content-activated layer or a content-agnostic layer. The second layer 1320 can be a content-activated layer or a content-agnostic layer. In one embodiment, the camera-captured layer 1305 can be partially transparent. In one embodiment, the first layer 1310 can be partially transparent to enable the visibility of the camera-captured layer 1305 and the second layer 1320 behind the first layer 1310. In one embodiment, the image or video data captured by the camera 1301 and displayed in the camera-captured layer 1305 can be used to interact with content on the first layer 1310 and/or the second layer 1320. For example, the first layer 1310 and the second layer 1320 can include 2-dimensional or 3-dimensional content. In one embodiment, the 3-dimensional content can include content from more than one layer.

In one embodiment, content in the camera-captured layer 1305 can be used to trigger actions in the first layer 1310 and/or the second layer 1320. In one embodiment, the first layer 1310 and the second layer 1320 can be content-activated layers. As an example, the camera 1301 can capture video data of a user at a first location 1302. In one embodiment, the first location 1302 can be a location in three-dimensional space. In one embodiment, the first location 1302 can be located in a frame of the camera-captured layer 1305. In one embodiment, the action in the video data can be identified via inspection of the frame buffer, as is described in greater detail herein. The action of the user at the first location 1302 can be used to trigger an interaction with the first layer 1310, wherein the interaction with the first layer 1310 can be executed at a target location 1311 in the first layer 1310. In one embodiment, the target location 1311 can be determined based on the first location 1302 of the action. In one embodiment, the target location 1311 can be determined based on the 2-dimensional or 3-dimensional in the first layer 1310. In one embodiment, the target location 1311 can be determined based on the image or video data captured by the camera 1301, including, but not limited to, a user location, a user gaze, or a user action. In one embodiment, the video data captured by the camera 1301 can include video data of a user at a second location 1303. In one embodiment, the second location 1303 can be a location in three-dimensional space. In one embodiment, the second location 1303 can be located in a frame of the camera-captured layer 1305. The action of the user at the second location 1303 can be used to trigger an interaction with the second layer 1320, wherein the interaction with the second layer 1320 can be executed at a target location 1321 in the second layer 1320. In one embodiment, the interaction with the second layer 1320 can be executed without an effect on the first layer 1310. In one embodiment, the target location 1321 can be based on the second location 1303. For example, the interaction can be a selection of a graphic at the target location 1321 in the second layer 1320.

In one embodiment, the volumetric composite can include additional layers, including, but not limited, to a third layer 1330 and a fourth layer 1340. In one embodiment, the layers in the volumetric composite can be placed in any order. For example, the third layer 1330 can be in between the first layer 1310 and the second layer 1320, while the fourth layer 1340 can be behind the second layer 1320. According to one embodiment, the third layer 1330 and the fourth layer 1340 can be content-agnostic layers. The 2-dimensional or 3-dimensional content in the third layer 1330 and the fourth layer 1340 may not be affected by actions identified in the video data and the camera-captured layer. In one embodiment, the order of the layers can change in the volumetric composite. In one embodiment, the order of the layers may affect the transparency and/or visibility of 2-dimensional or 3-dimensional content in one or more of the layers. In one embodiment, a layer can become a content-activated layer, a content-agnostic layer, or a camera-captured layer. For example, the third layer 1330 can become a content-activated layer and the second layer 1320 can become a content-agnostic layer. The combination of content-activated layers and content-agnostic layers can create an interactive volumetric composite.

In some embodiments, one or more of the disclosed functions and capabilities may be used to enable users to see a volumetric composite of layers of transparent computing from a 360-degree optical lenticular perspective wherein a user's gaze, gestures, movements, position, orientation, or other characteristics observed by cameras are a basis to calculate, derive and/or predict the 360-degree optical lenticular perspective from which users see the volumetric composite of layers of transparent computing displayed on screens. Further, users can engage with a 3-dimensional virtual environment displayed on screens consisting of layers of transparent computing placed behind the 3-dimensional virtual environment displayed on screens, placed in front of a 3-dimensional virtual environment displayed on screens, and/or placed inside of the a 3-dimensional virtual environment displayed on screens wherein users can select and interact with objects in any layer of transparent computing to execute processes on computing devices while looking at the combination of the 3-dimensional virtual environment and the volumetric composite of layers of transparent computing from any angle of the 360-degree optical lenticular perspective available to users.

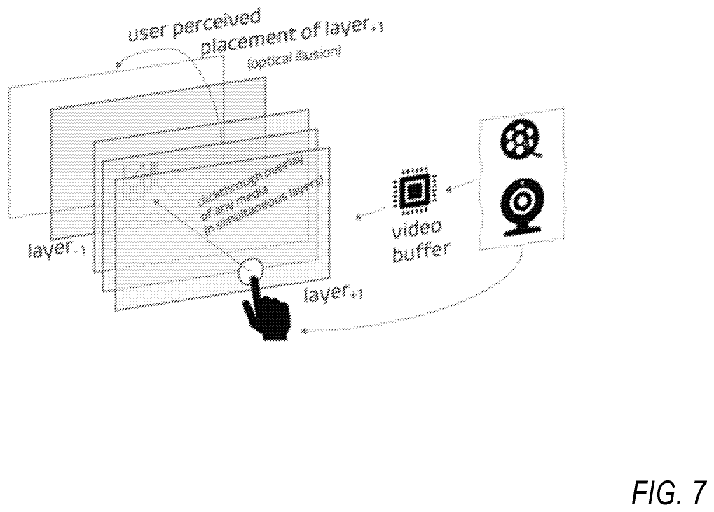

FIG. 7 illustrates an example of an augmented experience. One or more layers are retrieved from memory (e.g., frame buffers) and overlaid over one another as layer +1. Pixel characteristics, such as the transparency, of each pixel in the one or more layers of layer +1 can be configured to be semi- or fully transparent. These one or more layers in layer +1, now at least partially see-through, can be shown on top of, and in the same window as, layer −1 (e.g., operating system display). In this exemplary scenario, pixels on layer −1 have interactivity on, whereas pixels on layer +1 have interactivity off, though any pixel(s) in either layer can “move” between any of the layers by adjusting interactivity and/or transparency. The overall effect is an optical illusion for a user viewing the device, where the one or more layers from layer +1 seem to be displayed behind layer −1.

In an embodiment, interactivity can be utilized via input obtained via at a suitable input device. Examples of such suitable input devices include, but are not limited to, mouse, keyboard, touchscreen, touchpad, and microphone.

In an embodiment, interactivity can be utilized via gestures from a user (i.e., touch-ability). For example, one of the layers in layer +1 show live video of the user, and gesture-recognition techniques can be utilized to track the user as they interact with pixels in layer −1. This can look like displaying a live video of the user from a webcam buffer as a layer in layer +1, displaying an operating system desktop from a video buffer on layer −1, turning off the interactivity of all pixels on layer +1, and interacting with pixels on layer −1 using gesture information from a user. From a user's perspective, visual feedback of himself/herself via the live video can indicate, for instance, that their hand is located over a particular button or file in layer −1 for clicking.

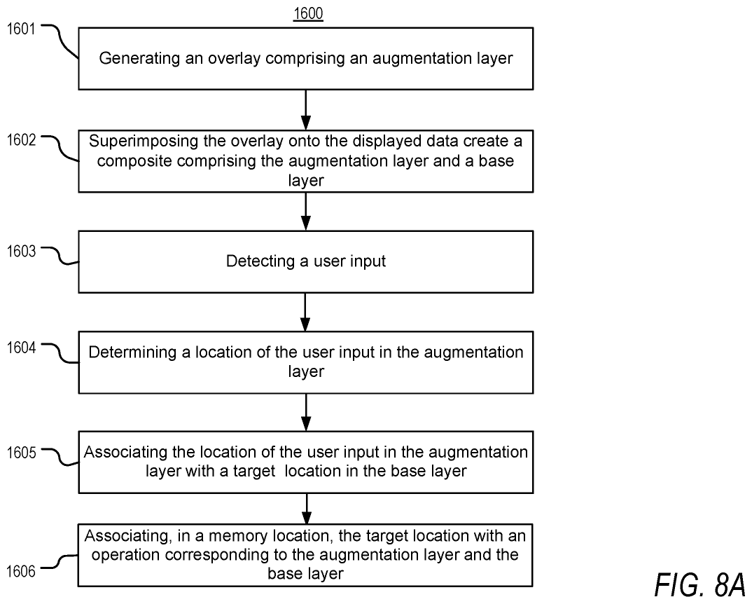

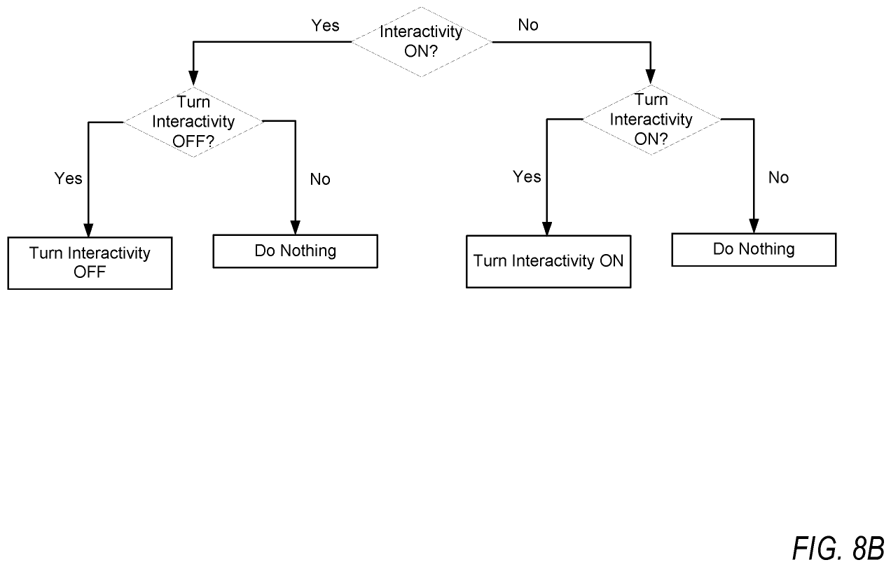

In order to achieve the functionality described above, the apparatus of the current disclosure can perform the following process. FIG. 8A depicts a flowchart outlining the process involved in a method 1600 of the present disclosure. The first step 1601 is generating an overlay comprising an augmentation layer. In an embodiment, the augmentation and corresponding content can be shown/displayed above the first and/or second layer, thereby creating a floating illusion. Details for how to generate an augmentation in step 1601 are discussed below.

The second step 1602 is superimposing the overlay onto the displayed data to create or generate a composite comprising the augmentation layer and a base layer. The superimposing can be performed such that the content is viewable while a portion of the base layer is obscured from view. The superimposing can look like placing the second layer (e.g., the overlay or an augmentation layer), represented by a second set of pixels, over the first layer (e.g., the base layer), represented by a first set of pixels, or vice versa, and adjusting the transparency of pixels within one or both layers to create a transparency effect so that both layers are visible.

Further, the superimposing can include controlling at least one pixel parameter, such as brightness, vibrancy, contrast, color, transparency, and/or an initial interactivity of one or more pixels. The control of such pixel parameters can be for one or more pixels in the first set of pixels, the second set of pixels, or another set of pixels. As an example, video footage from the frame buffer of a computer's webcam is placed over a webpage from a frame buffer of a graphics card, and the pixels in the video footage are adjusted to become slightly transparent. In this example, the pixels corresponding to the webpage can be altered or unaltered. In an embodiment, the superimposing can involve the creation or generation of a location record. The location record can be a map, table, array, database, or other similar data structure which is useful for recording or tabulating positions of pixels in the augmentation layer and the base layer.

The location record can be useful for determining a proper alignment of elements in the augmentation layer and the base layer such that proper obscuring of portions of the base layer is achieved. The location record can be further useful for tracking visibility of such obscured portions. In an embodiment, the location record can be useful in translocation as described above and further described below. For example, in an embodiment where the augmentation layer comprises elements which have a correspondence to elements in the base layer but are displayed at a location in the augmentation layer which is different from the location in the base layer, the location record can be useful for tracking such differences. In an embodiment, the location record can interact with the OS memory to determine an absolute location. The absolute location can relate the locations of the augmentation layer elements and base layer elements with, for example, hardware locations or specific pixels of a display.

The third step 1603 is detecting a user input. The input from the user can be transmitted from any type of input device, such as a mouse, keyboard, microphone, and a gesture-recognition sensor (e.g., camera, motion capture gloves). Such an input can correspond to any suitable action which may be performed by a user, for example left click, right click, drag, scroll, double-click, key press, etc.

Usage of a gesture-recognition sensor can allow a user to have a touchless experience, where he/she can interact with pixels in the first and/or second layer using their body as the peripheral. The gesture-recognition sensor can track elements such as a user's finger(s), eye(s), face, hand(s), and pose. Different gestures can correspond to different commands. For instance, a tapping action with a finger can represent a single left-click, a tapping action with two fingers can represent a single right-click, pinching can represent zooming, and so on. The combination of superimposing a live video of a user (with interactivity off) over another layer (with interactivity on) allows the user to interact with the latter layer using gestures, while at the same time, seeing themselves on the former layer as a visual cue to where they are relative to pixels in the latter layer. From a device perspective, the device 101 can collect gesture data of a user utilizing a camera and send the gesture data to the processing device (e.g., CPU or GPU) to analyze and interpret the gesture data to update pixels accordingly.

The fourth step 1604 is determining a location of the user input in the augmentation layer. In an embodiment, the location of the user input in the augmentation layer is determined from a memory. In an embodiment, the memory is a main memory as described above. Such a main memory may be an OS memory, a computing memory, or a combination thereof. For example, the OS memory can determine, track, request, poll, or record a location of a cursor which is able to be controlled by a mouse. The location may be assigned x- and y-coordinates corresponding to the x- and y-coordinates of a certain pixel in a display. These x- and y-coordinates may be recorded at the time an input, e.g., a click, is detected. The system or apparatus may then access, request, or otherwise obtain the x- and y-coordinates of the mouse at the time of the input (click). Such x- and y-coordinates can then be associated with a particular pixel in the augmentation. In another example, the mouse can generate a signal which is transferred to the OS memory upon a click, the signal comprising parameters of the click. Upon receipt of the signal, the OS memory can determine the location of the click. This may be referred to as a “memory location determination”.

In an embodiment, the location of the user input may be determined from the location of an input marker. Such an input marker may be any suitable input marker which makes the location of an element which acts to convey a user input, e.g., a cursor, pointer, or the like. This input marker can be visible on the screen. The visibility on the screen, and therefore the location can be determined by accessing the frame buffer and analyzing a frame. Such accessing and analyzing can be performed as described above. The detection of the input marker can be performed as described above. The system or apparatus can analyze the frame to determine the location of the input market at the time of the input. The location of the input marker can be determined relative to other pixels in the augmentation or can be determined from x- and y-coordinates. This may be referred to as a “computer vision location determination”. This may be particularly advantageous in an embodiment in which the user input is a gesture.

The fifth step 1605 is associating the location of the user input in the augmentation layer with a target location in the base layer. In an embodiment, this associating can be performed by the device which performs the superimposing. In an embodiment, the associating can be performed using the location record as described above. In an embodiment, the associating can be performed by passing the location of the user input in the augmentation layer or a request comprising such a location to the memory, which can return a response comprising base layer elements associated with that location in the base layer. For example, the x- and y-coordinates in the augmentation layer can be looked up in the location record to find the corresponding x- and y-coordinates in the base layer. In another example, the x- and y-coordinates in the augmentation layer can be passed to the OS memory. The OS memory can then return or provide information comprising base layer elements associated with the same x- and y-coordinates in the base layer. In another example, the associating can be performed by a computer vision approach as described above. In such an example, the location in the augmentation layer can be analyzed or inspected in the frame buffer to determine a location in the base layer. That location in the base layer can be analyzed, for example, by object detection, to determine if there are elements in the base layer at that location.

The sixth step 1606 is associating, in a memory location, the target location with an operation corresponding to the augmentation layer and the base layer. This associating should be performed such that the user input in the augmentation layer can activate an input in the base layer.

In general, the memory location can be a location in the OS memory, the computing memory, or both, as described above. In an embodiment, the location of the user input in the augmentation layer can be associated with a specific memory location associated with the augmentation layer. That location can contain a parameter setting or controlling interactivity for the pixel, object, or layer where the user input was detected. That location can perform a function or instruct another piece of software to pass an instruction to another memory location for performing a function or operation. For example, a portion of the augmentation layer can be associated with the display of a “save” icon. When user input is detected in the augmentation layer at the location of the displayed save icon, the input can be associated with the save function as performed by a piece of software (e.g., Microsoft PowerPoint). In an embodiment, the location of the user input can be associated with a portion of memory or a memory location which is currently serving or associated with that piece of software (e.g., Microsoft PowerPoint). That piece of software can then receive the input or an instruction related to the input to perform a specific function (e.g. save the file).

In such an example, if the software is in the augmentation layer, the method can proceed directly to associating the input location with a memory location. If the software is in the base layer, the method can determine the location within the base layer as described above. In another example, the memory location associated with the augmentation can pass an instruction to an OS memory location to register an input at the specific input location in the base layer. The OS memory can then take appropriate action as if the input was received directly at that location in the absence of the augmentation layer. That appropriate action can involve passing an instruction or associating the user input with, for example, a computing memory location associated with a specific piece of software. In an embodiment, the location of the user input can prevent or otherwise inhibit the performance of a function or operation or the instruction of another piece of software to pass an instruction to another memory location for performing a function or operation. For example, the user input can be detected and associated with a location where interactivity is off. Interactivity being off can cause a memory location associated with the augmentation to perform a function which prevents another memory location from performing a function. For example, the memory location associated with the augmentation can pass an instruction to an OS memory location to disregard the input.

In an embodiment, the associating the user input in the augmentation with a memory location is performed by determining, based on the memory location, the target location in the base layer, and associating the target location in the base layer with a function or operation of the interaction in a memory location. For example, this associating can bypass the OS memory location in the example described above. In another example, the augmentation or processing circuitry associated with the augmentation can access the OS memory to determine a location of memory associated with the input location, then determine a computing memory location associated with a piece of software associated with the input location from the OS memory. Then, the user input can be directly passed to the computing memory location with the software, so that software can perform a function. This example does not involve passing the location of the input or an instruction to the OS memory, which then passes such information to a piece of software associated with the computing memory location.

In an embodiment, the method involves detecting or determining an interactivity of the pixel at the location of the user input in the augmentation. In such an embodiment, the method can be truncated so as to not associate the location of the user input pin the augmentation with a function of the interaction in a memory location. Such truncation may be advantageous for reducing computational intensity or resource utilization by the augmentation.

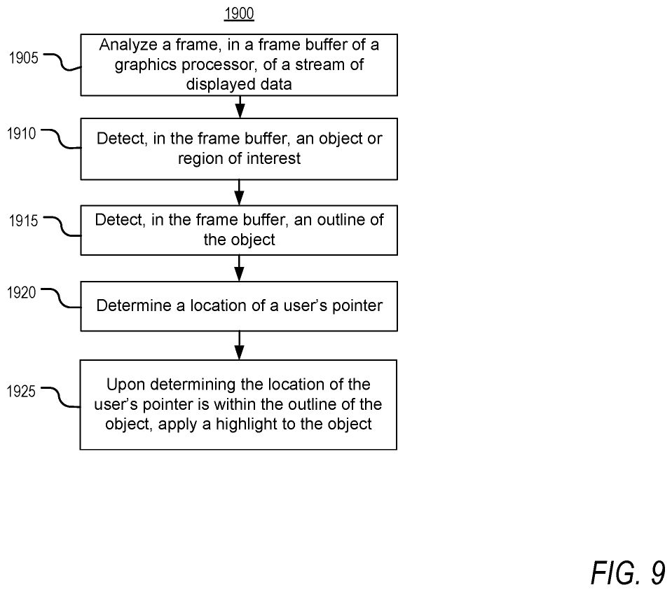

FIG. 9 is a flow chart of a method 1900 of detecting a target object and highlighting the object, according to an embodiment of the present disclosure.

In an embodiment, in step 1905, the first device 701 can analyze a frame in the frame buffer of the GPU. As previously described, the first device 701 can inspect the stream of data being outputted by the first device's 701 video or graphics card and onto the display of the first device 701. That is, the first device 701 can access a frame buffer of the GPU and analyze, frame by frame, in the frame buffer, the outputted stream of data which can include the displayed data.

In an embodiment, in step 1910, the first device 701 can detect, in the frame buffer, an object or a region of interest. The object can be, for example, a shape, text, etc.

In an embodiment, in step 1915, the first device 701 can detect, in the frame buffer, an outline of the object.

In an embodiment, in step 1920, the first device 701 can determine a location of a user's pointer or a location corresponding to an interaction. The pointer can be, for example, a hand of the user captured via a camera of the first device 701 having a camera buffer. The pointer can be, for example, a mouse pointer corresponding to a peripheral, such as a mouse, manipulated by the user. The interaction can be using, for example, the pointer.

In an embodiment, in step 1925, the first device 701 can monitor a movement of the user's pointer and determine a location or predicted location of the user's pointer. Upon determining the location or predicted location of the user's pointer is within the outline of the object, the first device 701 can apply a visual modification to the object. The visual modification can be, for example, a highlight to the outline of the object.

In an embodiment, the user pointer can be associated with a peripheral device such as a mouse or a keyboard. For example, the user pointer can be a cursor, which is controlled by a mouse. In an embodiment, the user pointer can be associated with an interactive instrument such as a stylus, a remote, or a gaming controller, which can also be used to control a cursor.

The method 1900 can be further described with reference to the schematic of FIG. 10A. To this end, FIG. 10A is a schematic illustrating a user camera feed mixed with user display content for the purposes of highlighting and hotspotting, according to an embodiment of the present disclosure. In an embodiment, with reference to step 1705 of FIG. 9, the first device 701 can display a video feed or video data of the user captured using a camera of the first device 701 along with user display content. The user display content can be, for example, a desktop of the first device 701 including software applications being run. For example, the software application can be a web browser with a news article being viewed by the user. For example, the software application can be a Microsoft PowerPoint slide deck being viewed by the user. That is, the user display content can be the previously described stream of data being outputted by the first device's 701 video or graphics card and onto the display of the first device 701.

In an embodiment, the video feed and the user display content can be included in separate layers of the volumetric composite of FIG. 6. For example, the video feed is in the camera-captured layer 1305 and the user display content is in any of the first layer 1310, the second layer 1320, the third layer 1330, and so on (which can be content-activated layers or content-agnostic layers). As previously described, the transparency of any layer can be adjusted to result in the appearance of one layer in front of or behind another layer. Furthermore, predetermined portions of the layer can be segmented out and the transparency of the predetermined portions can be adjusted.

As shown in FIG. 10A, the video feed of the user can be displayed with the user display content. Notably, in a predetermined area of the display known as a projector area 1015, the first device 701 can both display the video feed of the user (appearing transparently in the background of projector area 1015 and the user display content. The projector area 1015 can be the area encompassed by the dashed lines shown in FIG. 10A. The predetermined area can occupy an entire area of the display of the first device 701, or a portion of the area of the display. In an embodiment, the predetermined area of the display represents a majority of the total area of the display. For example, the predetermined area of the display is the entire area of the display when the software application performing the method described herein is in a full screen mode. Again, notably, the user display content is displayed over the predetermined area of the display similar to the video feed. That is, the user display content is displayed over the entire area of the display when the software application performing the method described herein is in a full screen mode.

FIG. 10A also illustrates the projector area 1015 including the user display content having detectable objects. For example, as shown, the user display content displayed with the user video feed is a slide in a slide deck. The slide can include text boxes 1080 and images 1070. The images 1070 can be formatted into a rectangular shape and arranged in a lateral line, while the text boxes 1080 can be displayed below corresponding images 1070 in a columnar arrangement. As shown, the images 1070 and text boxes 1080 have been detected and visually modified by the first device 701 for demonstrative purposes. Originally, the images 1070 and text boxes 1080 do not include any visual modifications, such that the text boxes 1080 can appear without any bright fill and the images 1070 can appear without any bright outline. However, the first device 701 can detect the images 1070 and the text boxes 1080 (again, without any visual modifications) and determine the images 1070 and text boxes 1080 are target objects or areas of interest. For example, the first device 701 can use the aforementioned computer vision techniques to detect the images 1070 and the text boxes 1080. For example, the text can be detected using optical character recognition (OCR) and the first device 701 can determine a box to form around the detected text to form the text box 1080, which can then be visually modified as described herein. For example, the images 1070 can be detected using myriad techniques, such as edge detection, machine learning processes, etc. described further herein.

In one advantage, this mixing of the video feed with the user display content over the same area allows the user of the first device 701, via the video feed, to interact with the user display content that the user appears behind or in front of That is, since both the user display content and the video data occupy a similar area and can be viewed at the same time by adjusting a transparency of each layer, the user of the first device 701 can enhance any discussion revolving around the user display content when engaged in an electronic communication session with another participant. One way of enhancing a discussion around the user display content is through haptics, such as by gesturing/pointing at objects or text in the user display content. Gestures or pointing cause the application executing on the first device 701 to execute predetermined reactions associated with the objects or text and generally highlight, otherwise emphasize, or manipulate the content in the user display content.

To this end, FIG. 10B is a schematic illustrating the detection of a body part of the user, according to an embodiment of the present disclosure. FIGS. 10A and 10B display the same user in a video feed in the background but in FIG. 10A, the appearance of the user is more transparent (less opaque) than the appearance of the same user in FIG. 10B. In an embodiment, in FIG. B, the first device 701 can detect the hands of the user. As shown, the hands of the user are open and each finger, as well as the palms, can be detected and recognized as independent features of the user's hand. The user can use the user's hands to interact with the user display content since both the user display content and the user's video feed are both visible. Note here, that the objects in the user display content appear in a less visually modified state as compared to the appearance described in FIG. 10A. Upon detecting the objects in the user display content, the first device 701 can either apply no visual modification or apply a slight visual modification (as shown). That is, each image 1070 detected by the first device 701 can have a white, semi-transparent border applied around an outline of the image 1070, and each text box 1080 detected by the first device 701 can have a white, semi-transparent fill applied to an interior of the text box 1080 (and optionally applied to an outline of the text box 1080 as well). This can aid in visibility of the detected objects for the user to see and subsequently interact with. The user can either use his/her hand in the open configuration shown to begin interacting with the objects, or the user can change the configuration of the user's hands in order to trigger a predetermined mode. The different configurations and corresponding modes can be pre-set, or defined by the user in a user profile.

To this end, FIG. 10C is a schematic illustrating a gesture, according to an embodiment of the present disclosure. In an embodiment, the user can adjust the fingers of the user's hand to form a first configuration having two fingers up with the other fingers retracted into the palm of the hand. The first configuration can correspond to a first mode for applying a first visual modification. The first mode can remain active while the first configuration is maintained to apply the first visual modification, or the first mode can remain active until a second configuration or series of configurations is detected by the first device 701, at which point the first mode can be exited.

For example, the first mode can result in a visual indicator 1090 appearing at a tip of the hand's pointer finger. The visual indicator 1090 can have a shape with an outline or appear as a point. A movement and position of the visual indicator 1090 can be monitored by the first device 701. The visual indicator 1090 can, based on the position of the visual indicator 1090, cause the aforementioned visual modification to any object of the display and also at the same position as the visual indicator 1090. The user can move the visual indicator 1090 over a text box 1080 and the first device 701 can adjust the appearance of the text box 1080 accordingly upon detecting the position of the visual indicator 1090 overlaps an area of the object.

To this end, FIG. 10D is a schematic illustrating visual modification of the object, according to an embodiment of the present disclosure. In an embodiment, the first device 701 can appear to improve the visibility of the text box 1080 by decreasing a transparency of the text box 1080 (or similarly increasing an opacity of the text box 1080). In effect, the text box 1080 or object in general is highlighted in appearance. The white, previously semi-transparent fill of the text box 1080 fill can appear brighter and less transparent (more opaque). Similarly, the black color of the text itself can appear darker and less transparent (more opaque). Other visual modifications can be, for example, a blinking outline, a blinking fill, a shimmering or twinkling outline, a shimmering or twinkling fill, a color-changing outline, a color-changing fill, a shaking effect applied to the object, a size-changing effect applied to the object, a rotational effect applied to the object, and a movement applied to the object, among others.

In an embodiment, the visual modification can be applied to an object by modifying the transparency of one or more layers of displayed data at the location of the object. The layers of displayed data can include the user display content, where the object is located, as well as displayed data from additional sources, including the user video feed. In an embodiment, the layers of displayed data can include layers in the user display content. For example, the visual modification can be applied to the object to increase the visibility of the object. Before the visual modification is applied, the object in the user display content and the user video feed can both be displayed at the location of the object with partial transparency such that both the user display content and the user video feed are visible or partially visible. An exemplary method of applying the visual modification to the object to make the object more visible can include decreasing the transparency of the object as well as increasing the transparency of the user video feed at the location of the object so that the user video feed is less visible and the object is more visible.

In an embodiment, visual modifications can be applied to the object as well as to its surroundings in order to generate the desired visual effect. For example, a visual effect can be a perceived depth between the object and remaining content in the user display content, such that the object appears elevated or three-dimensional. A visual modification such as brightening and enlarging can be applied to the object itself in order to achieve this effect. In addition, visual modifications can be applied to an area surrounding the object—e.g., outside of the outline of the object—to create a drop shadow or blurring surrounding the object to achieve the depth or distance. This can result in, for example, the appearance of the area surrounding the object to be out of focus. In an embodiment, the degree of visual modification (e.g., brightening, enlarging, darkening, shading, blurring, etc.) as well as the area to which the visual modification is applied can be calculated and applied based on a desired measure of distance or depth between the object and the surroundings of the object.

Notably, FIG. 10D presents the appearance of the user manipulating the user display content, but again, the video feed of the user and the user display content are on entirely separate layers. Thus, by overlaying the two layers with one another and tracking the user's gestures in the layer with the video feed to trigger a reaction in the layer with the user display content, the appearance of the user interacting with user display content is formed.

In an embodiment, the position of the visual indicator 1090 need not overlap the area of the object. Instead, as the first device 701 monitors the position as well as the movement of the visual indicator 1090 (FIG. 10C), the first device 701 can continually generate and update a vector of the visual indicator 1090. For example, the vector of the visual indicator 1090 can describe a direction and a speed of the visual indicator 1090. Thus, the first device 701 can determine a position, speed, and acceleration of the visual indicator 1090. For example, the user can be moving the user's hand across the slide and begin the movement slowly. As the movement speed increases, the change in position of the visual indicator 1090 also increases in magnitude. For example, the visual indicator 1090 can move 50 pixels over a first time period, then 100 pixels over a second time period, then 150 pixels over a third time period. The time period can be, for example, 1 second. The acceleration of the visual indicator 1090 can therefore be 50 pixels per second per second (50 pixels/s 2).

While moving through the middle of the slide, the user may maintain a constant movement speed and thus the acceleration can be 0 pixels/s 2. As the user approaches a desired position in the slide, the movement speed can begin to decrease with a detectable deceleration. For example, the deceleration can likely be of the same magnitude of the acceleration, or −50 pixels/s 2. Thus, the first device 701 can analyze the movement speed and direction of the visual indicator 1090 to determine the acceleration of the initial movement and the likely deceleration of the movement as the user approaches the desired position in the slide along the direction of the movement, at which time the first device 701 can determine the likely final position the user desires to reach.

For example, the first device 701 can determine that the user started moving slowly at a first text box of the slide with constant movement acceleration, reached a constant movement rate at a fourth text box of the slide (i.e. zero movement acceleration) and maintained the constant movement rate until reaching a fifth text box of the slide, at which point the first device 701 can detect the deceleration of the movement. At that point, the first device 701 can then determine that the deceleration rate will likely be similar to the acceleration rate. For example, the acceleration rate reached a plateau after moving over 4 text boxes and began deceleration after moving over the fifth text box. Therefore, the first device 701 can determine or predict that the user is trying to move and hover over the ninth text box (i.e., that the user will stop moving the visual indicator 1090 once reaching the ninth text box). As the visual indicator 1090 approaches the ninth text box, the first device 701 can apply the visual modification to the ninth text box even before the visual indicator 1090 overlaps any area of the ninth text box. The visual modification can be triggered when the visual indicator 1090 reaches a predetermined distance away from the ninth text box. For example, the predetermined distance can be 1 pixel, or 5 pixels, or 10 pixels, or 100 pixels, or a ratio of the pixels traveled by the visual indicator 1090 compared to a dimension of the ninth text box.

In an embodiment, the user can exit the first mode by opening the user's hand, wherein all fingers are detected to be extended. In an embodiment, the first mode can be sustained even when the user's hand is open, and instead, the series of hand configurations needed to exit the first mode can include a transition from the open hand, to a clenched first, and back to the open hand.

Returning to the detection of the objects in the user display content, the object or area of interest can be text, shapes or areas with high luminosity, or common shapes, or any object placed by the user. Furthermore, a threshold can be set wherein detected objects are not visually modified unless a metric of the object exceeds the threshold. In such a manner, not every detected object is visually modified as the user moves the visual indicator 1090 across the projector area 1015 (FIG. 10B). For example, applying the blinking fill visual modification to any detected object in the projector area 1015, large or small, can be visually unappealing or distracting. Therefore, in an embodiment, the threshold can correspond to an area of the object relative to the projector area 1015. For example, the first device 701 can only apply the visual modification to the detected object having an area exceeding 20% of the area of the projector area 1015. Otherwise, no visual modifications are applied. In one embodiment, detected objects can be visually modified based on content associated with the detected objects.

In an embodiment, the first device 701 may not automatically detect the object and apply the visual modification. As such, the user can therefore use the visual indicator 1090 (FIG. 10C), via the mouse pointer or the gesture with his/her hand, and manually outline the region of interest for applying the visual modification. For example, the user can enter into a second mode using a different gesture that can provide the visual indicator 1090 that is configured to draw in the second mode. Taking the example of the slide deck of FIG. 10A, if any one of the images 1070 or text boxes 1080 was not automatically detected and visually modified by the first device 701, the user can enter into the second mode to draw a shape around the desired area of the user display content. In doing so, the image 1070 or text box 1080 can be identified as a region of interest and visually modified similar to the other automatically detected images 1070 and text boxes 1080. In an embodiment, the user's mouse pointer can also be used to draw the shape around the desired object or region of interest. To this end, FIG. 10E is a schematic illustrating user input to identify objects and regions of interest, according to an embodiment of the present disclosure. As can be seen, the selected area of interest 1060, which in FIG. 10E encapsulates a thumbnail for a video, has a visual modification applied. In particular, the thumbnail (selected area of interest 1060) opacity has increased and the video feed of the user at the same location (shown behind the thumbnail) and area as the thumbnail is more transparent and less visible.

Furthermore, in an embodiment, the selected object or area of interest 1060 can be duplicated and retained as an image copy for immediate or later use. To this end, FIG. 10F is a schematic illustrating duplication of the selected area of interest 1060, according to an embodiment of the present disclosure. In an embodiment, the user can use a gesture or the mouse pointer to generate a duplication selected area 1060a. For example, the user can double-click with the mouse pointer and, upon determining the mouse pointer is positioned within an outline or area of the selected area of interest 1060 (FIG. 10E), the first device 701 can duplicate the selected area of interest 1060. The duplicated selected area 1060a (FIG. 10F) can then be manipulated via the mouse pointer. For example, the duplicated selected area 1060a can be moved to another position in the displayed data and pinned for when the user desires to discuss the duplicated selected area 1060a at a later time. For example, the duplicated selected area 1060a can be a comical scene or image in a video and the user can transmit the duplicated selected area 1060a (either immediately or in the future) via a messaging application to another user.

In an embodiment, the user can be a non-human user, such as a robot or other electromechanical device. The non-human user may or may not resemble a human in appearance or anatomy. The user pointer can be identified based on a component of the non-human user. According to one example, the user pointer can be identified based on a robotic arm, wherein the robotic arm is captured in a video feed and can execute gestures such as those described herein. According to one example, the user pointer can be identified based on a mechanical rod, wherein the mechanical rod is captured in a video feed. The mechanical rod can include, for example, an identifying or a landmark feature at an end of the mechanical rod for tracking the mechanical rod movement.

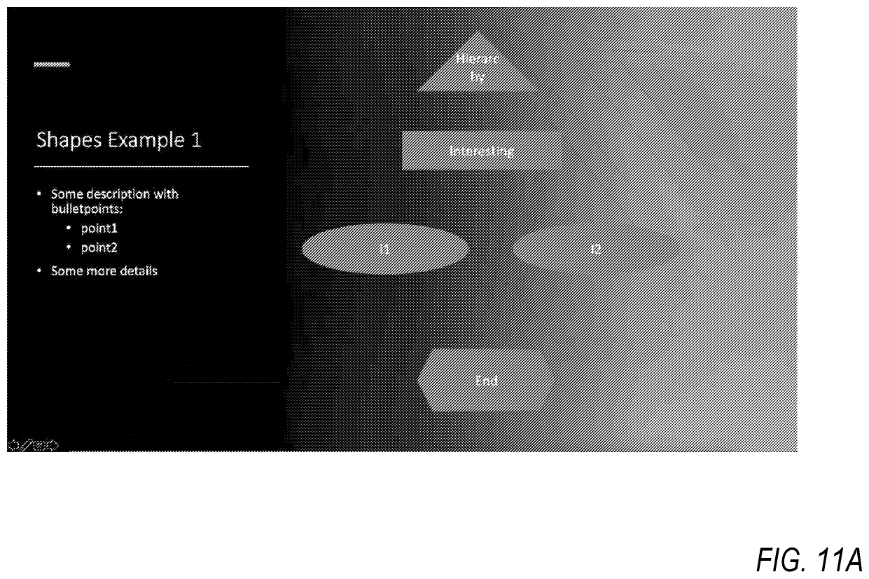

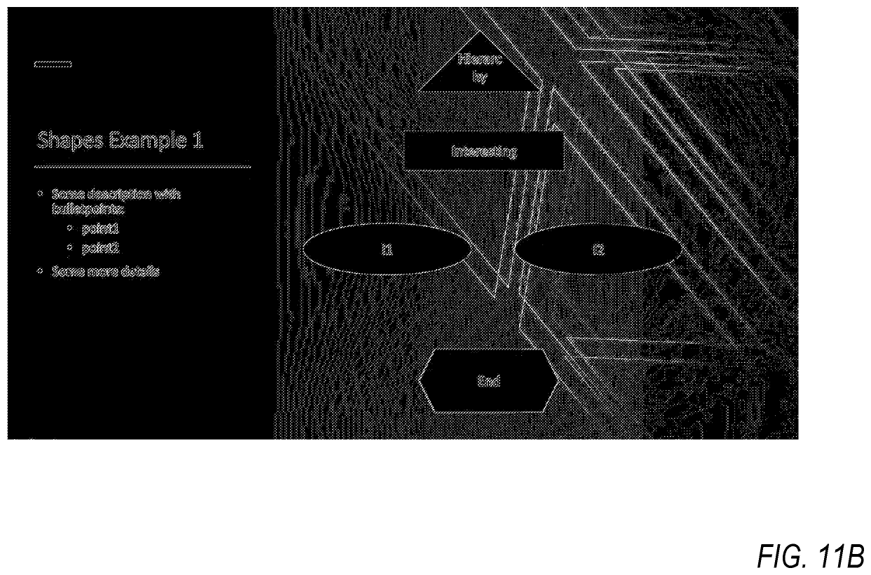

FIG. 11A is a schematic illustrating a slide before object detection, according to an embodiment. In an embodiment, the slide can include text and shapes, as well as varying color information.

FIG. 11B is a schematic illustrating a slide after object detection, according to an embodiment. In an embodiment, the objects or areas of interest can be detected using edge detection. The edge detection process can include applying a Laplace transform to the analyzed frame inspected from the frame buffer of the graphics processor. This can result in an image having edges of the objects converted to a binary value based on a transition from an outside of the object to an inside of the object. That is to say, anywhere there is an object edge, the object edge will appear highly contrasted with the background of the slide and the object area. As shown, edges of the letters in the text, as well as edges of the shapes are converted to white lines, while everything else is converted to black. That is, positive and negative pixels are generated, wherein the edges can be the conversion of pixels to white pixels or positive pixels, and non-edge areas can be the conversion of pixels to black pixels or negative pixels. Thus, any negative pixels detected within a substantially enclosed shape of white or positive pixels can be determined to be the area of the enclosed shape of white or positive pixels. Further, a bilateral filter can be applied to differentiate horizontal and vertical edges and reduce noise. Notably, once the edges of the objects are identified, the area of the objects need not be of concern since the edges define the object, and the visual modification is applied to the entire object or just the edges (outline) upon determining the visual indicator 1090 overlaps with the area within the edges of the object or approaches the edge of the object.

In an embodiment, the detected edges and/or the detected objects can be associated with coordinates or other indicators of location. The locations of the detected edges can be used to apply visual modifications to the objects defined by the edges as well as to areas outside of the edges, e.g., the surroundings of the objects. The locations of the detected edges can also be used to identify objects for application of visual modifications. For example, if a portion of the visual indicator 1090 is within the boundaries of the detected edges, the object defined by the detected edges can be selected for modification. The portion of the visual indicator 1090 can be, for example, a majority of the visual indicator 1090.

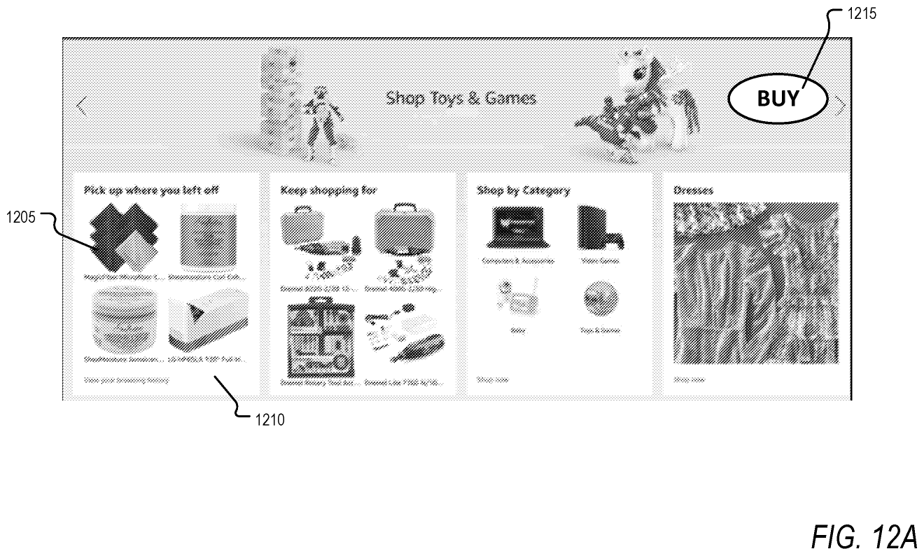

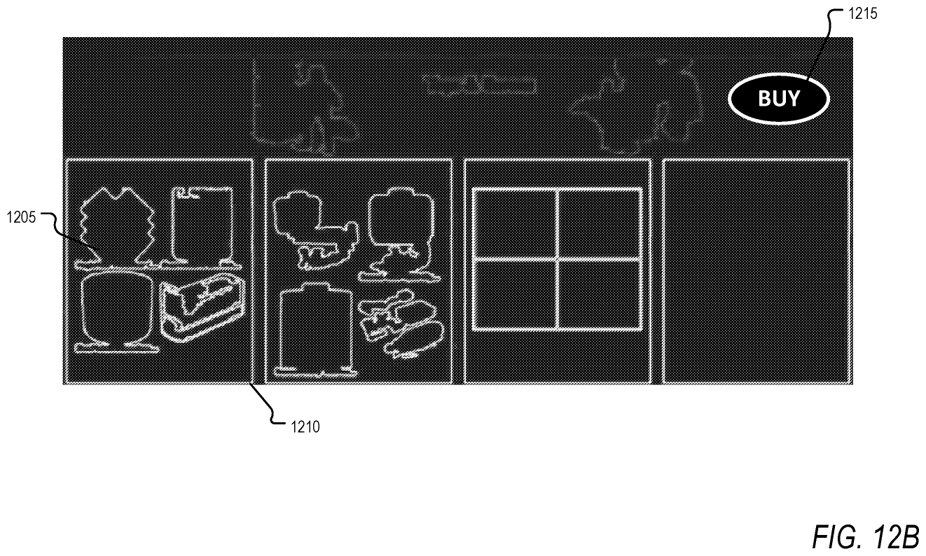

FIG. 12A is a schematic of an example of object detection on a web browser, according to an embodiment of the present disclosure. FIG. 12B is a schematic of the example of the object detection of FIG. 12A with object edges shown, according to an embodiment of the present disclosure. In an embodiment, a page of the web browser includes products displayed at an online retailer and the object edges and category boxes of the products can be detected using the method described with reference to FIG. 11A and FIG. 11B. As shown in FIG. 12B, the products themselves can be detected and a first outline can be applied to the products. Further, the category boxes denoting separate groups of the products can be detected and a second outline can be applied. Further, header text and header products can be additionally detected, and a third outline can be applied. In an embodiment, the first outline can denote a high-detail object detection with high weight for visual modification, the second outline can denote a low-detail object detection with low weight for visual modification, and the third outline can denote a detected object with no weight for visual modification while still being segmented for other predetermined uses. For example, the movement of the user's hand over a set of fabric squares 1205 (top-left outline in a left-most detected category box 1210) can result in the fabric squares 1205 being visually modified, while the category box 1210 can remain unmodified. Based on a predetermined visual modification threshold, the objects detected can either be visually modified or not visually modified. For example, with the predetermined visual modification threshold set low, both the set of fabric squares 1205 and the category box 1210 around the fabric squares 1205 in the previous example can be visually modified instead of just the set of fabric squares 1205.

In an embodiment, the objects and areas of interest can be detected using common patterns and shapes. For example, the web browser page includes a button 1215 having an elliptical shape which can be easily detected without the need to use edge detection (but it may be appreciated that edge detection can also be used to detect the elliptical shape). For example, the web browser page includes a jar of cream (bottom-left outline of the same left-most detected category box 1210) having a cylindrical shape, which can be easily detected. Similarly, the aforementioned category box 1210 encapsulating the set of fabric squares 1205 and the jar of cream can have a rectangular shape, which can be easily detected based on the known shapes. For example, a social media application's interface can include an area of the screen having an image displayed with a set of common shapes or patterns disposed below. The common patterns can be, for example, a heart, a speech bubble disposed adjacent to the heart, and an arrow disposed adjacent to the speech bubble. The common patterns can be easily detected and identified for visual modification (upon the user's gesture prompting such an action).

In an embodiment, the objects and areas of interest can be detected using a machine learning process. As shown in FIG. 12A, the elliptically shaped button 1215 can be a “BUY” button used by the online retailer for initiating a purchase of the products. Notably, the button 1215 can be common disposed at the same location with a similar appearance for many users. Thus, training data including images 1070 of displayed data having, for example, the BUY button 1215 disposed in the same approximate position can be used to train the machine learning process. Furthermore, a function corresponding to actuation of the BUY button 1215 can be assigned to the BUY button 1215 upon detection. Furthermore, non-training data can be analyzed iteratively by the machine learning model to generate detection results, which can be annotated or corrected and fed back into the machine learning process to improve the detection accuracy. Thus, the machine learning process can be trained to detect objects out of the norm or are uncommon with high accuracy.

In general, the machine learning process can use a neural network trained using a training dataset generated from images having the objects and areas of interest included therein. In a training phase, the training data can be generated using ground truth or known images. In a noise determination phase, detection results from analyzing an unknown image sample can be processed and then applied to the trained neural network with the result from the neural network being the updated detection model. Subsequently, in a correction phase, noise or error correction (incorrect or missed detections) of the detection process can be performed to reduce or remove the noise from subsequent analysis and detection of the objects in additional images, and an improved detection accuracy can then be obtained.

In an embodiment, objects in the user display content can be modified based on more than one user pointer. The more than one user pointers can be pointers from the same user or from a different user. In one embodiment, the projector area can include displayed data from one or more sources. For example, the projector area can include user display content as well user video feeds from more than one user device. The user devices can be in an electronic communication session, e.g., a video conferencing session. The electronic communication session can include a networked device 750. The networked device 750 can be, for example, a server functioning as a communications platform as a service (CPaaS). The CPaaS is a cloud-based delivery model that allows organizations to add real-time communications capabilities, such as voice, video, and messaging, to applications by deploying application program interfaces (APIs). The CPaaS can be, for example, Amazon Chime, Twilio, Agora, etc. The CPaaS can facilitate aggregation and transmission of content between devices. The networked device 750 can receive streams of content from each device and send some or all of the streams of content back to each device. For example, in a video conference session (the electronic communication session), the CPaaS can receive a live video feed (video data) from each participant device in the video conference session. The CPaaS can then transmit the live video feeds from all participants to each participant device. In an embodiment, in general, the CPaaS can customize the data transmitted to each participant device after receiving data from each participant device where the data can be the video data, shared content data, etc. Notably, the CPaaS provides a method to allow the user of the sharing device to share content inside the electronic communication session.

Each of the user video feeds can include at least one detected user pointer, wherein the location of the at least one user pointer can be determined as has been described herein for each user video feed. In one embodiment, a networked device, e.g., a server, can determine the location of the at least one user pointer in each of the user video feeds separately. The networked device can inspect the frame buffer or camera buffer of each user device to identify at least one user pointer and the location of the at least one user pointer in each frame or camera buffer. The networked device can then transmit the location of the at least one user pointer and/or additional parameters of the at least one user pointer (e.g., a size, a user ID) to a user device displaying the user display content and the user video feeds. The user device can display the user display content and the user video feeds with visual indicators 1090 (FIG. 10C) at the locations of the user pointers based on the user pointer location data. In one embodiment, the location of the at least one user pointer in a frame of a first user device display can be mapped to a location on a second user device display. For example, the frame of the first user device display can include a full-screen, single user video feed of the first user. The second user device display can display the first user video feed and a second user video feed, e.g., in side-by-side panels. The location of a user pointer as displayed in the frame of the first device can be mapped to a location in the frame of the second device according to the scaling of the first user video feed in the frame of the second device. In one embodiment, the mapping can be used to determine which object to apply visual modifications to, based on the location of the user pointer and the associated visual indicator 1090.

In one embodiment, a device such as the networked device can determine the location of the user pointers from one or more user video feeds in a single frame of displayed data. For example, the device can generate a composite frame, wherein the composite frame includes the user display content, a first user video feed, and a second user video feed, where the first user video feed and the second user video feed are overlayed on the user display content. The location of user pointers in the first user video feed and the second user video feed can be determined in the composite frame by inspecting the composite frame, e.g., in the frame buffer, as has been described herein. In one embodiment, identifiers can be assigned to user pointers to distinguish the user pointers in a frame. For example, a user ID can be assigned to a user pointer based on the source of the video feed including the user pointer. The user ID can be used to differentiate between pointers of a first user and pointers of a second user. In one embodiment, a type of pointer can be assigned to a user pointer. The type of pointer can be, for example, a size, a number, or another label such as a finger label (index finger, ring finger, etc.). The assignment of identifiers to the user pointers can enable simultaneous interactions from the user pointers with objects. For example, a first user can highlight a first object and a second user can highlight a second object simultaneously. In one embodiment, the visual modification applied to an object can depend on the source of the user pointer. In one embodiment, the visual modification applied to an object can depend on a number of user pointers present in a current frame. For example, a primary visual modification can be applied to a first object and a secondary visual modification can be applied to a second object.

Embodiments of the subject matter and the functional operations described in this specification can be implemented by digital electronic circuitry (on one or more of devices 701-70n, 750, and 7001), in tangibly embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of data processing apparatus, such as the devices of FIG. 1 (e.g., devices 701-70n, 750, 7001) or the like. The computer storage medium can be a machine-readable storage device, a machine-readable storage substrate, a random or serial access memory device, or a combination of one or more of them.

The term “data processing apparatus” refers to data processing hardware and may encompass all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, Subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA an ASIC.

Computers suitable for the execution of a computer program include, by way of example, general or special purpose microprocessors or both, or any other kind of central processing unit. Generally, a CPU will receive instructions and data from a read-only memory or a random access memory or both. Elements of a computer are a CPU for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more Such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients (user devices) and servers. A client and server are generally remote from each other and typically interact through a communication network. The relationship of client and server arises by virtue of computer programs running on the respective computers and having a client-server relationship to each other. In an embodiment, a server transmits data, e.g., an HTML, page, to a user device, e.g., for purposes of displaying data to and receiving user input from a user interacting with the user device, which acts as a client. Data generated at the user device, e.g., a result of the user interaction, can be received from the user device at the server.

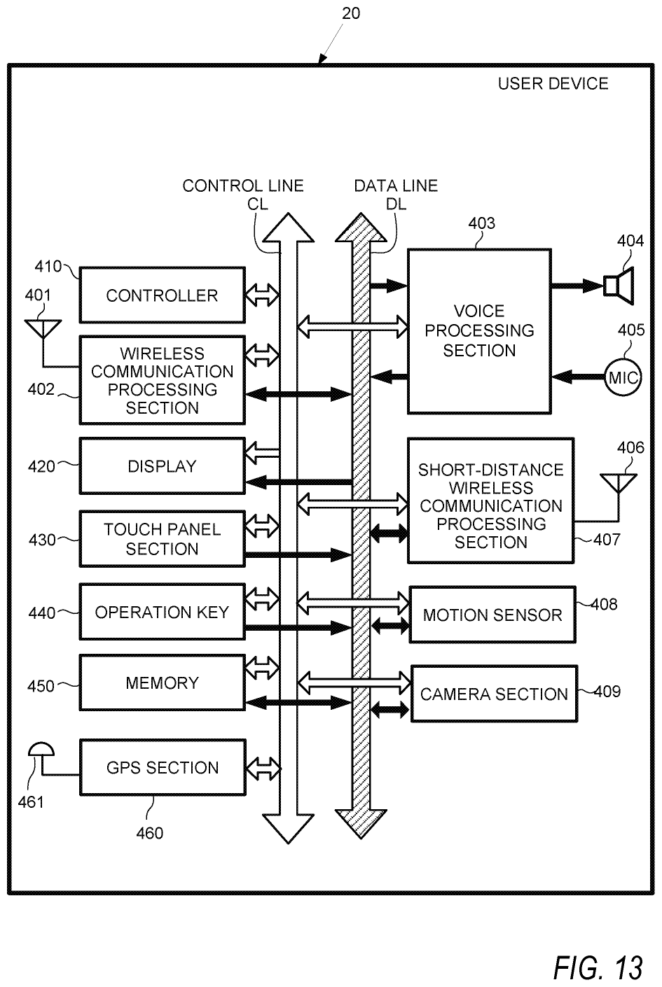

Electronic user device 20 shown in FIG. 13 can be an example of one or more of the devices shown in FIG. 1. In an embodiment, the electronic user device 20 may be a smartphone. However, the skilled artisan will appreciate that the features described herein may be adapted to be implemented on other devices (e.g., a laptop, a tablet, a server, an e-reader, a camera, a navigation device, etc.). The exemplary user device 20 of FIG. 13 includes processing circuitry, as discussed above. The processing circuitry includes one or more of the elements discussed next with reference to FIG. 13. The electronic user device 20 may include other components not explicitly illustrated in FIG. 13 such as a CPU, GPU, frame buffer, etc. The electronic user device 20 includes a controller 410 and a wireless communication processor 402 connected to an antenna 401. A speaker 404 and a microphone 405 are connected to a voice processor 403.

The controller 410 may include one or more processors/processing circuitry (CPU, GPU, or other circuitry) and may control each element in the user device 20 to perform functions related to communication control, audio signal processing, graphics processing, control for the audio signal processing, still and moving image processing and control, and other kinds of signal processing. The controller 410 may perform these functions by executing instructions stored in a memory 450. Alternatively or in addition to the local storage of the memory 450, the functions may be executed using instructions stored on an external device accessed on a network or on a non-transitory computer readable medium.

The memory 450 includes but is not limited to Read Only Memory (ROM), Random Access Memory (RAM), or a memory array including a combination of volatile and non-volatile memory units. The memory 450 may be utilized as working memory by the controller 410 while executing the processes and algorithms of the present disclosure. Additionally, the memory 450 may be used for long-term storage, e.g., of image data and information related thereto.

The user device 20 includes a control line CL and data line DL as internal communication bus lines. Control data to/from the controller 410 may be transmitted through the control line CL. The data line DL may be used for transmission of voice data, displayed data, etc.

The antenna 401 transmits/receives electromagnetic wave signals between base stations for performing radio-based communication, such as the various forms of cellular telephone communication. The wireless communication processor 402 controls the communication performed between the user device 20 and other external devices via the antenna 401. For example, the wireless communication processor 402 may control communication between base stations for cellular phone communication.

The speaker 404 emits an audio signal corresponding to audio data supplied from the voice processor 403. The microphone 405 detects surrounding audio and converts the detected audio into an audio signal. The audio signal may then be output to the voice processor 403 for further processing. The voice processor 403 demodulates and/or decodes the audio data read from the memory 450 or audio data received by the wireless communication processor 402 and/or a short-distance wireless communication processor 407. Additionally, the voice processor 403 may decode audio signals obtained by the microphone 405.

The exemplary user device 20 may also include a display 420, a touch panel 430, an operation key 440, and a short-distance communication processor 407 connected to an antenna 406. The display 420 may be a Liquid Crystal Display (LCD), an organic electroluminescence display panel, or another display screen technology. In addition to displaying still and moving image data, the display 420 may display operational inputs, such as numbers or icons which may be used for control of the user device 20. The display 420 may additionally display a GUI for a user to control aspects of the user device 20 and/or other devices. Further, the display 420 may display characters and images received by the user device 20 and/or stored in the memory 450 or accessed from an external device on a network. For example, the user device 20 may access a network such as the Internet and display text and/or images transmitted from a Web server.

The touch panel 430 may include a physical touch panel display screen and a touch panel driver. The touch panel 430 may include one or more touch sensors for detecting an input operation on an operation surface of the touch panel display screen. The touch panel 430 also detects a touch shape and a touch area. Used herein, the phrase “touch operation” refers to an input operation performed by touching an operation surface of the touch panel display with an instruction object, such as a finger, thumb, or stylus-type instrument. In the case where a stylus or the like is used in a touch operation, the stylus may include a conductive material at least at the tip of the stylus such that the sensors included in the touch panel 430 may detect when the stylus approaches/contacts the operation surface of the touch panel display (similar to the case in which a finger is used for the touch operation).

In certain aspects of the present disclosure, the touch panel 430 may be disposed adjacent to the display 420 (e.g., laminated) or may be formed integrally with the display 420. For simplicity, the present disclosure assumes the touch panel 430 is formed integrally with the display 420 and therefore, examples discussed herein may describe touch operations being performed on the surface of the display 420 rather than the touch panel 430. However, the skilled artisan will appreciate that this is not limiting.

For simplicity, the present disclosure assumes the touch panel 430 is a capacitance-type touch panel technology. However, it should be appreciated that aspects of the present disclosure may easily be applied to other touch panel types (e.g., resistance-type touch panels) with alternate structures. In certain aspects of the present disclosure, the touch panel 430 may include transparent electrode touch sensors arranged in the X-Y direction on the surface of transparent sensor glass.

The touch panel driver may be included in the touch panel 430 for control processing related to the touch panel 430, such as scanning control. For example, the touch panel driver may scan each sensor in an electrostatic capacitance transparent electrode pattern in the X-direction and Y-direction and detect the electrostatic capacitance value of each sensor to determine when a touch operation is performed. The touch panel driver may output a coordinate and corresponding electrostatic capacitance value for each sensor. The touch panel driver may also output a sensor identifier that may be mapped to a coordinate on the touch panel display screen. Additionally, the touch panel driver and touch panel sensors may detect when an instruction object, such as a finger is within a predetermined distance from an operation surface of the touch panel display screen. That is, the instruction object does not necessarily need to directly contact the operation surface of the touch panel display screen for touch sensors to detect the instruction object and perform processing described herein. For example, in an embodiment, the touch panel 430 may detect a position of a user's finger around an edge of the display panel 420 (e.g., gripping a protective case that surrounds the display/touch panel). Signals may be transmitted by the touch panel driver, e.g. in response to a detection of a touch operation, in response to a query from another element based on timed data exchange, etc.

The touch panel 430 and the display 420 may be surrounded by a protective casing, which may also enclose the other elements included in the user device 20. In an embodiment, a position of the user's fingers on the protective casing (but not directly on the surface of the display 420) may be detected by the touch panel 430 sensors. Accordingly, the controller 410 may perform display control processing described herein based on the detected position of the user's fingers gripping the casing. For example, an element in an interface may be moved to a new location within the interface (e.g., closer to one or more of the fingers) based on the detected finger position.

Further, in an embodiment, the controller 410 may be configured to detect which hand is holding the user device 20, based on the detected finger position. For example, the touch panel 430 sensors may detect fingers on the left side of the user device 20 (e.g., on an edge of the display 420 or on the protective casing), and detect a single finger on the right side of the user device 20. In this exemplary scenario, the controller 410 may determine that the user is holding the user device 20 with his/her right hand because the detected grip pattern corresponds to an expected pattern when the user device 20 is held only with the right hand.

The operation key 440 may include one or more buttons or similar external control elements, which may generate an operation signal based on a detected input by the user. In addition to outputs from the touch panel 430, these operation signals may be supplied to the controller 410 for performing related processing and control. In certain aspects of the present disclosure, the processing and/or functions associated with external buttons and the like may be performed by the controller 410 in response to an input operation on the touch panel 430 display screen rather than the external button, key, etc. In this way, external buttons on the user device 20 may be eliminated in lieu of performing inputs via touch operations, thereby improving watertightness.

The antenna 406 may transmit/receive electromagnetic wave signals to/from other external apparatuses, and the short-distance wireless communication processor 407 may control the wireless communication performed between the other external apparatuses. Bluetooth, IEEE 802.11, and near-field communication (NFC) are non-limiting examples of wireless communication protocols that may be used for inter-device communication via the short-distance wireless communication processor 407.

The user device 20 may include a motion sensor 408. The motion sensor 408 may detect features of motion (i.e., one or more movements) of the user device 20. For example, the motion sensor 408 may include an accelerometer to detect acceleration, a gyroscope to detect angular velocity, a geomagnetic sensor to detect direction, a geo-location sensor to detect location, etc., or a combination thereof to detect motion of the user device 20. In an embodiment, the motion sensor 408 may generate a detection signal that includes data representing the detected motion. For example, the motion sensor 408 may determine a number of distinct movements in a motion (e.g., from start of the series of movements to the stop, within a predetermined time interval, etc.), a number of physical shocks on the user device 20 (e.g., a jarring, hitting, etc., of the electronic device), a speed and/or acceleration of the motion (instantaneous and/or temporal), or other motion features. The detected motion features may be included in the generated detection signal. The detection signal may be transmitted, e.g., to the controller 410, whereby further processing may be performed based on data included in the detection signal. The motion sensor 408 can work in conjunction with a Global Positioning System (GPS) section 460. The information of the present position detected by the GPS section 460 is transmitted to the controller 410. An antenna 461 is connected to the GPS section 460 for receiving and transmitting signals to and from a GPS satellite.

The user device 20 may include a camera section 409, which includes a lens and shutter for capturing photographs of the surroundings around the user device 20. In an embodiment, the camera section 409 captures surroundings of an opposite side of the user device 20 from the user. The images of the captured photographs can be displayed on the display panel 420. A memory section saves the captured photographs. The memory section may reside within the camera section 109 or it may be part of the memory 450. The camera section 409 can be a separate feature attached to the user device 20 or it can be a built-in camera feature.

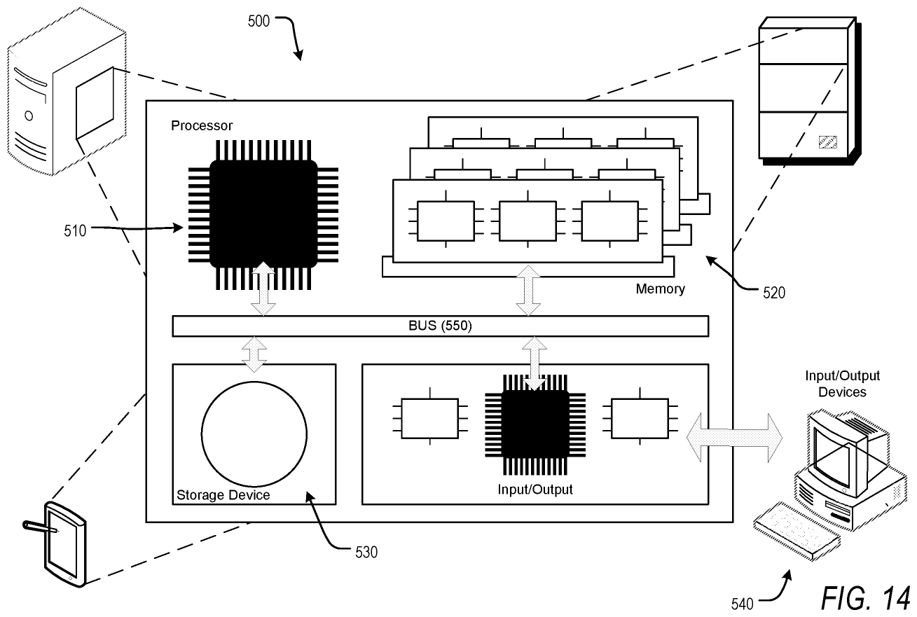

An example of a type of computer is shown in FIG. 14. The computer 500 can be used for the operations described in association with any of the computer-implement methods described previously, according to one implementation. For example, the computer 500 can be an example of devices 701, 702, 70n, 7001, or a server (such as networked device 750). The computer 700 includes processing circuitry, as discussed above. The networked device 750 may include other components not explicitly illustrated in FIG. 14 such as a CPU, GPU, frame buffer, etc. The processing circuitry includes one or more of the elements discussed next with reference to FIG. 12. In FIG. 14, the computer 500 includes a processor 510, a memory 520, a storage device 530, and an input/output device 540. Each of the components 510, 520, 530, and 540 are interconnected using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the computer 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the computer 500. In one implementation, the storage device 530 is a computer-readable medium. In various different implementations, the storage device 530 may be a floppy disk device, a hard disk device, an optical disk device, or a tape device.

The input/output device 540 provides input/output operations for the computer 500. In one implementation, the input/output device 540 includes a keyboard and/or pointing device. In another implementation, the input/output device 540 includes a display unit for displaying graphical user interfaces.

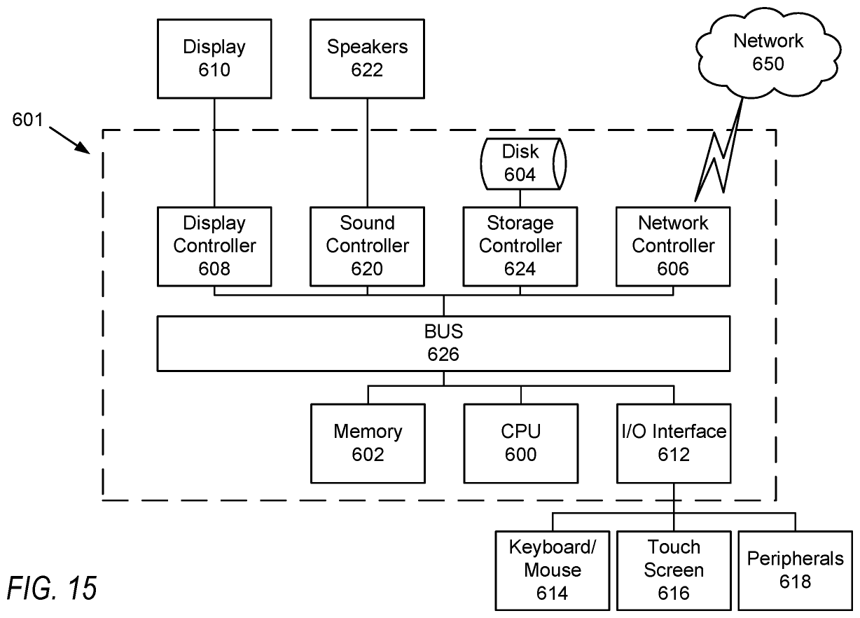

Next, a hardware description of a device 601 according to exemplary embodiments is described with reference to FIG. 15. In FIG. 15, the device 601, which can be the above described devices of FIG. 1, includes processing circuitry, as discussed above. The processing circuitry includes one or more of the elements discussed next with reference to FIG. 15. The device 701, may include other components not explicitly illustrated in FIG. 15 such as a CPU, GPU, frame buffer, etc. In FIG. 15, the device 701 includes a CPU 600 which performs the processes described above/below. The process data and instructions may be stored in memory 602. These processes and instructions may also be stored on a storage medium disk 604 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the device 601 communicates, such as a server or computer.

Further, the claimed advancements may be provided as a utility application, background daemon, or component of an operating system, or combination thereof, executing in conjunction with CPU 600 and an operating system such as Microsoft Windows, UNIX, Solaris, LINUX, Apple MAC-OS and other systems known to those skilled in the art.

The hardware elements in order to achieve the device 601 may be realized by various circuitry elements, known to those skilled in the art. For example, CPU 600 may be a Xenon or Core processor from Intel of America or an Opteron processor from AMD of America, or may be other processor types that would be recognized by one of ordinary skill in the art. Alternatively, the CPU 600 may be implemented on an FPGA, ASIC, PLD or using discrete logic circuits, as one of ordinary skill in the art would recognize. Further, CPU 600 may be implemented as multiple processors cooperatively working in parallel to perform the instructions of the processes described above. CPU 600 can be an example of the CPU illustrated in each of the devices of FIG. 1.

The device 601 in FIG. 15 also includes a network controller 606, such as an Intel Ethernet PRO network interface card from Intel Corporation of America, for interfacing with network 650 (also shown in FIG. 1), and to communicate with the other devices of FIG. 1. As can be appreciated, the network 650 can be a public network, such as the Internet, or a private network such as an LAN or WAN network, or any combination thereof and can also include PSTN or ISDN sub-networks. The network 650 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The device 601 further includes a display controller 608, such as a NVIDIA GeForce GTX or Quadro graphics adaptor from NVIDIA Corporation of America for interfacing with display 610, such as an LCD monitor. A general purpose I/O interface 612 interfaces with a keyboard and/or mouse 614 as well as a touch screen panel 616 on or separate from display 610. General purpose I/O interface also connects to a variety of peripherals 618 including printers and scanners.

A sound controller 620 is also provided in the device 601 to interface with speakers/microphone 622 thereby providing sounds and/or music.

The general purpose storage controller 624 connects the storage medium disk 604 with communication bus 626, which may be an ISA, EISA, VESA, PCI, or similar, for interconnecting all of the components of the device 601. A description of the general features and functionality of the display 610, keyboard and/or mouse 614, as well as the display controller 608, storage controller 624, network controller 606, sound controller 620, and general purpose I/O interface 612 is omitted herein for brevity as these features are known.

While this specification contains many specific implementation details, these should not be construed as limitations on the scope of what may be claimed, but rather as descriptions of features that may be specific to particular embodiments.

Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

Embodiments of the present disclosure may also be as set forth in the following parentheticals.
(1) A device, comprising processing circuitry configured to detect, in displayed data present in a frame buffer, a region of interest, determine a location corresponding to an interaction, and upon determining the interaction has a position or predicted position located within the region of interest, apply a visual modifier to the region of interest.
(2) The device of (1), wherein the interaction is associated with a location, which is a location corresponding to a pointer.
(3) The device of either (1) or (2), wherein the processing circuitry is further configured to determine the location of the pointer by detecting the pointer in the displayed data present in the frame buffer.
(4) The device of any one of (1) to (3), wherein the processing circuitry is further configured to determine the location of the pointer by detecting the pointer in a main memory of the device.
(5) The device of any one of (1) to (4), wherein the visual modifier causes the region of interest to be displayed on the display device.
(6) The device of any one of (1) to (5), wherein the interaction corresponds to an input of audio data with a microphone.
(7) The device of any one of (1) to (6), wherein applying the visual modifier is associated with a change in interactivity of the region of interest.
(8) The device of any one of (1) to (7), wherein the processing circuitry is further configured to detect the region of interest by detecting known shapes in the displayed data.
(9) The device of any one of (1) to (8), wherein the processing circuitry is further configured to detect the region of interest by using a machine learning process trained to detect the region of interest.
(10) The device of any one of (1) to (9), wherein the machine learning process is trained using a set of images including the region of interest with known detection parameters.
(11) A method for a device, the method comprising detecting, in displayed data present in a frame buffer, a region of interest; determining a location corresponding to an interaction; and upon determining the interaction has a position or predicted position located within the region of interest, applying a visual modifier to the region of interest.
(12) The method of (11), wherein the interaction is associated with a location, which is a location corresponding to a pointer.
(13) The method of either (11) or (12), further comprising determining the location of the pointer by detecting the pointer in the displayed data present in the frame buffer.
(14) The method of any one of (11) to (13), further comprising determining the location of the pointer by detecting the pointer in a main memory of the device.
(15) The method of any one of (11) to (14), wherein the visual modifier causes the region of interest to be displayed on a display device.
(16) The method of any one of (11) to (15), wherein the interaction corresponds to an input of audio data with a microphone.
(17) The method of any one of (11) to (16), wherein applying the visual modifier is associated with a change in the interactivity of the region of interest.
(18) The method of any one of (11) to (17), further comprising detecting the region of interest by detecting known shapes in the displayed data.
(19) The method of any one of (11) to (18), further comprising detecting the region of interest by using a machine learning process trained to detect the region of interest.
(20) A non-transitory computer-readable storage medium for storing computer-readable instructions that, when executed by a computer, cause the computer to perform a method, the method comprising detecting, in displayed data present in a frame buffer, a region of interest; determining a location corresponding to an interaction; and upon determining the interaction has a position or predicted position located within the region of interest, applying a visual modifier to the region of interest.

Thus, the foregoing discussion discloses and describes merely exemplary embodiments of the present disclosure. As will be understood by those skilled in the art, the present disclosure may be embodied in other specific forms without departing from the spirit thereof. Accordingly, the disclosure of the present disclosure is intended to be illustrative, but not limiting of the scope of the disclosure, as well as other claims. The disclosure, including any readily discernible variants of the teachings herein, defines, in part, the scope of the foregoing claim terminology such that no inventive subject matter is dedicated to the public.

1. A device, comprising:
processing circuitry configured to
detect, in displayed data present in a frame buffer, a region of interest,
determine a location corresponding to an interaction, and
upon determining the interaction has a position or predicted position located within the region of interest, apply a visual modifier to the region of interest.

2. The device of claim 1, wherein the interaction is associated with a location, which is a location corresponding to a pointer.

3. The device of claim 2, wherein the processing circuitry is further configured to determine the location of the pointer by detecting the pointer in the displayed data present in the frame buffer.

4. The device of claim 2, wherein the processing circuitry is further configured to determine the location of the pointer by detecting the pointer in a main memory of the device.

5. The device of claim 1, wherein the visual modifier causes the region of interest to be displayed on the display device.

6. The device of claim 1, wherein the interaction corresponds to an input of audio data with a microphone.

7. The device of claim 1, wherein applying the visual modifier is associated with a change in interactivity of the region of interest.

8. The device of claim 1, wherein the processing circuitry is further configured to detect the region of interest by detecting known shapes in the displayed data.

9. The device of claim 1, wherein the processing circuitry is further configured to detect the region of interest by using a machine learning process trained to detect the region of interest.

10. The device of claim 9, wherein the machine learning process is trained using a set of images including the region of interest with known detection parameters.

11. A method for a device, the method comprising:
detecting, in displayed data present in a frame buffer, a region of interest;
determining a location corresponding to an interaction; and
upon determining the interaction has a position or predicted position located within the region of interest, applying a visual modifier to the region of interest.

12. The method of claim 11, wherein the interaction is associated with a location, which is a location corresponding to a pointer.

13. The method of claim 12, further comprising determining the location of the pointer by detecting the pointer in the displayed data present in the frame buffer.

14. The method of claim 12, further comprising determining the location of the pointer by detecting the pointer in a main memory of the device.

15. The method of claim 11, wherein the visual modifier causes the region of interest to be displayed on a display device.

16. The method of claim 11, wherein the interaction corresponds to an input of audio data with a microphone.

17. The method of claim 11, wherein applying the visual modifier is associated with a change in the interactivity of the region of interest.

18. The method of claim 11, further comprising detecting the region of interest by detecting known shapes in the displayed data.

19. The method of claim 11, further comprising detecting the region of interest by using a machine learning process trained to detect the region of interest.

20. A non-transitory computer-readable storage medium for storing computer-readable instructions that, when executed by a computer, cause the computer to perform a method, the method comprising:
detecting, in displayed data present in a frame buffer, a region of interest;
determining a location corresponding to an interaction; and
upon determining the interaction has a position or predicted position located within the region of interest, applying a visual modifier to the region of interest.
